(19) United States
(12) Patent Application Publication
(10) Pub. No.: US 2026/0350289 A1
(43) Pub. Date: Nov. 5, 2026

(54) DEVICE AND METHOD OF GENERATING MODIFIED LAYOUT PLAN

(71) Applicant: Taiwan Semiconductor Manufacturing Company, Ltd., Hsinchu (TW)

(72) Inventors: Sachin KUMAR, Hsinchu (TW); Yu WANG, Hsinchu (TW); Kumar Narayan LALGUDI, Hsinchu (TW)

(73) Assignee: Taiwan Semiconductor Manufacturing Company, Ltd., Hsinchu (TW)

(21) Appl. No.: 19/198,641

(22) Filed: May 5, 2025

(51) Int. Cl. G06F 30/3953; G06F 119/10

(52) U.S. Cl. CPC G06F 30/3953; G06F 2119/10

(57) ABSTRACT

An embodiment method of generating a modified layout plan for a semiconductor device includes obtaining electromigration (EM) violation information indicating N signal-level EM violations associated with N nets in a present layout plan, and M[n] EM-violating metallization segments of an n-th one of the N signal-level EM violations. The method includes determining a set of resulting metallization segments based on performing N EM fixing operations for the N signal-level EM violations, generating an updated routing that modifies a present routing of the present layout plan based on the set of resulting metallization segments, and saving, to a memory of a processing device, a modified layout plan that is based on the present layout plan with inclusion of the set of resulting metallization segments and the updated routing.

### BACKGROUND

Electromigration (EM) is a term used to describe the transport of metal atoms when an electric current flows through a metallic structure in an integrated circuit (IC). Over time, EM causes the formation of hillocks (e.g., based on accumulation of excess metal) and/or voids (e.g., based on depletion of initial metal) in the metallic structure which, in turn, tends to result in short circuits (hillocks) or open circuits (voids). In many applications, a higher current density in a metallic structure leads to a greater level of EM effect. As the metallic structure size in a semiconductor device decreases (e.g., at a lower metallization layer or due to the advancement of manufacturing technology), the operating frequency increases (e.g., at a high-frequency switching node), and/or the current level carried thereon increases (e.g., for a greater driving capability). There are studies regarding designing the metallic structures to reduce the EM effect.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a semiconductor device, in accordance with some embodiments.

FIG. 2 is a cross-sectional view of a semiconductor device, in accordance with some embodiments.

FIG. 3A is a flowchart of a process flow of generating a layout plan for a semiconductor device, in accordance with some embodiments.

FIG. 3B is a flowchart including various stages of a signal EM fixing process in FIG. 3A, in accordance with some embodiments.

FIGS. 4A-4D are plan views of a portion of a layout plan at various stages of a signal EM fixing process, in accordance with some embodiments.

FIG. 5 is a flowchart of a signal EM fixing process considering one or more EM violations, in accordance with some embodiments.

FIG. 6 is a simplified plan view of a layout plan for a semiconductor device, in accordance with some embodiments.

FIGS. 7A-7D are plan views of a portion of a layout plan at various stages of a signal EM fixing process based on a first example, in accordance with some embodiments.

FIGS. 8A-8B are plan views of cell instance examples with reassigned top pins, in accordance with some embodiments.

FIGS. 9A-9D are plan views of a portion of a layout plan at various stages of a signal EM fixing process based on a second example, in accordance with some embodiments.

FIGS. 10A-10B are plan views of a portion of a layout plan at various stages of a signal EM fixing process based on a third example, in accordance with some embodiments.

FIG. 11 is a flowchart of a method of generating a modified layout plan for a semiconductor device, in accordance with some embodiments.

FIG. 12 is a block diagram of an electronic design automation (EDA) system in accordance with some embodiments.

FIG. 13 is a block diagram of an IC manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, this disclosure may repeat reference numerals and/or letters in the various examples. This repetition is for simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “made of” may mean either “including” or “consisting of.” In this disclosure, the phrase “one of A, B, and C” means “A, B, and/or C” (A, B, C, A and B, A and C, B and C, or A, B and C), and does not mean one element from A, one element from B, and one element from C, unless otherwise described.

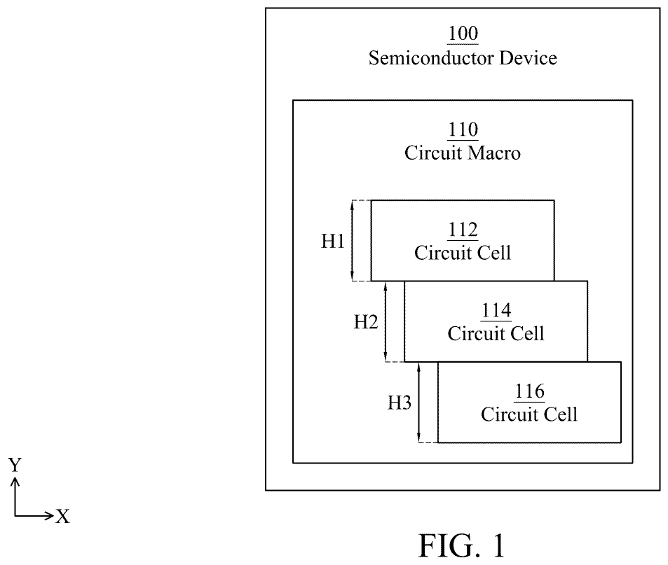

FIG. 1 is a block diagram of a semiconductor device 100, in accordance with some embodiments of the present disclosure. In some embodiments, semiconductor device 100 corresponds to an integrated circuit (IC) device or a portion of the IC device.

As in FIG. 1, semiconductor device 100 includes, among other things, at least one circuit macro 110. In some embodiments, circuit macro 110 corresponds to a set of semiconductor components configured as a memory, a controller, one or more logic gates, or the like. Circuit macro 110 includes, among other things, one or more circuit cells, such as circuit cell 112, circuit cell 114, and circuit cell 116. In some embodiments, each one of circuit cells 112, 114, and 116 corresponds to one or more layout cells including layout patterns indicative of transistors formed based on one or more active regions extending along a first horizontal direction (or a cell width direction, e.g., the X direction) and one or more gate structures extending along a second horizontal direction (or a cell height direction, e.g., the Y direction). In some embodiments, the one or more gate structures are spaced apart in the second horizontal direction based on a pitch between adjacent gate structures (e.g., a contacted poly pitch, or also referred to as a CPP in this disclosure). In some embodiments, each one of circuit cells 112, 114, and 116 (and the corresponding layout cells) has a corresponding cell height H1, H2, and H3 measurable along the second direction.

In some embodiments, each one of the layout cells of circuit cells 112, 114, and 116 includes layout patterns indicative of respective conductive lines within one or more metallization layers and electrically connecting various transistors of circuit cells 112, 114, and 116. In some embodiments, the semiconductor device 100 defines multiple power track regions extending along the first direction configured to carry a first supply voltage (e.g., VDD) or a second supply voltage (e.g., VSS or ground). In some embodiments, a circuit cell includes a first side extending along a power track region and a second side extending along another power track region. In some embodiments, a circuit cell that does not have any other power track region between the first side and the second side thereof is sometimes referred to as having a standard cell height. In some embodiments for a more compact design based on some processing nodes, a circuit cell having a standard cell height includes up to four or five metallization regions (other than the power track regions) extending along the first direction in a lowest metallization layer (also referred to as a MO layer) over the transistors of the circuit cell. In some embodiments, any of cell height H1, H2, and H3 has a standard cell height (e.g., a 1H cell), two standard cell heights (e.g., a 2H cell), or three standard cell heights (e.g., a 3H cell). In some embodiments, a circuit cell in circuit macro 110 corresponds to multiple standard cell heights or less than one standard cell height (e.g., a ½H cell).

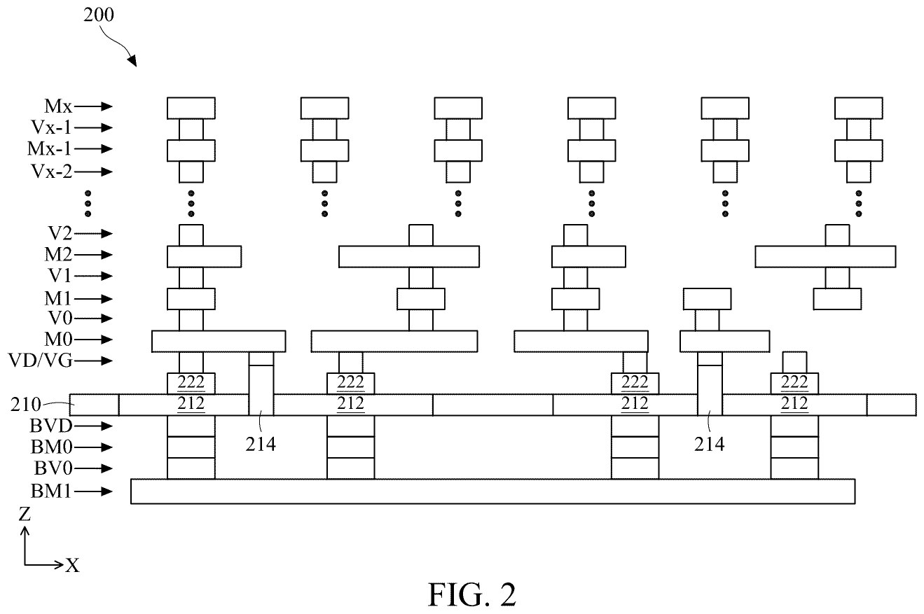

FIG. 2 is a cross-sectional view of a semiconductor device 200, in accordance with some embodiments. In some embodiments, semiconductor device 200 corresponds to semiconductor device 100 in FIG. 1. In some embodiments, the cross-sectional view is a simplified cross-sectional view, with many features simplified or not depicted.

Semiconductor device 200 in FIG. 2 includes a substrate 210 with active regions 212 and gate structures 214 formed on or partially in substrate 210. In this example, semiconductor device 200 includes metal-to-drain/source (MD) structures 222 coupled to the active regions 212. In this example, semiconductor device 200 includes via-to-drain/source (VD) structures coupled to MD structures 222 and via-to-gate (VG) structures coupled to gate structures 214 at a VD/VG layer above substrate 210 (with respect to a direction Z). In some embodiments, semiconductor device 200 further includes a plurality of metallization layers (e.g., M0, M1, M2, . . . , Mx-1, and Mx layers) and a plurality of via layers (e.g., V0, V1, V2, . . . , Vx-2, and Vx-1 layers) over the VD/VG layer and substrate 210 (x being a positive integer). In some embodiments, a number of metallization layers over substrate 210 ranges from 8 to 14. In some embodiments, Vx-1 layer denotes the via structures between and connecting conductive lines in Mx-1 layer and Mx layer. In some embodiments, M0 layer denotes the first metallization layer above substrate 210. In some embodiments, the plurality of metallization layers and the plurality of via layers include a conductive material including copper, aluminum, gold, tungsten, a combination thereof, or the like.

Semiconductor device 200 in FIG. 2, as a non-limiting example, further includes conductive structures disposed under substrate 210. For example, semiconductor device 200 further includes backside metallization layers BM0 and BM1 and backside via layers BVD and BV0. In this example, BVD layer denotes backside via structures between and connecting active regions 212 and backside conductive lines in BM0 layer; and BV0 layer denotes backside via structures between and connecting backside conductive lines in BM0 layer and BM1 layer. In some embodiments, BM0 layer denotes the first metallization layer under substrate 210. In this example, semiconductor device 200 includes two backside metallization layers and corresponding via layers. In some embodiments, a number of backside metallization layers under substrate 210 ranges from 2 to 6. In some embodiments, a portion or all of the backside conductive structures (e.g., backside metallization layers BM0 and BM1 and backside via layers BVD and BV0) are at least partially embedded in substrate 210. In some embodiments, backside metallization layers BM0 and BM1 and backside via layers BVD and BV0 include a conductive material including copper, aluminum, gold, tungsten, a combination thereof, or the like. In some other embodiments, a semiconductor device does not include any backside conductive structures.

In some embodiments, semiconductor device 200 includes one or more redistribution layers and conductive pad structures (not in FIG. 2) over the one or more redistribution layers. In some embodiments, semiconductor device 200 further includes conductive terminal structures (e.g., conductive bumps, copper pillar bumps, solder bumps, or the like, not in FIG. 2) over the conductive pad structures. In some embodiments, semiconductor device 200 also includes one or more backside redistribution layers and backside conductive pad structures (not in FIG. 2) under the one or more backside redistribution layers. In some embodiments, semiconductor device 200 also includes backside conductive terminal structures (e.g., conductive bumps, copper pillar bumps, solder bumps, or the like, not in FIG. 2) under the backside conductive pad structures.

In some embodiments, a layout plan for a semiconductor device is examined and analyzed for identifying possible electromigration (EM) issues. For example, one or more metallization segments of metallization layout patterns associated with a net of a circuit design of the semiconductor device may be identified as violating one or more EM compliance criteria (also referred to as a signal-level EM violation). To address the signal-level EM violations, in some applications, various fixing methods are used, including via pillar insertions, via ladder insertion, fanout splitting, and/or wire widening. Moreover, in some embodiments, the signal-level EM violations are fixed based on the creation of one or more added metallization segments based on an EM-violating metallization segment. In some embodiments, the creation of one or more added metallization segments is performed in a dynamic manner as needed to reduce the additional routing resources used for fixing the EM violations.

In some embodiments, one or more added metallization segments and the corresponding EM-violating metallization segment are marked as a set of virtual must-join pins corresponding to a pin of a cell instance. In some embodiments, the virtual must-join pins corresponding to conductive structures electrically coupled to upper layer conductive structures indicated by an upper layer segment. In a case that the upper layer segment is also identified as an EM-violating metallization segment, more added metallization segments are created based on the upper layer EM-violating metallization segment as needed. In some embodiments, these added metallization segments are created with enough access points on each layer for connections (e.g., for accommodating via structures). In some embodiments, for EM affected segments which are far away from cell pins or cell boundaries, parallel added metallization segments are created for fixing the EM affected segments without being marked as a set of must-join pins.

In some embodiments, the fixing described in this disclosure is done only for affected segments, and avoids major changes to the net routing and surrounding routes. In some embodiments, design rule check (DRC) violations are also reduced, since the one or more embodiments according to the present disclosure provide minimum routing changes based on an engineering change order (ECO) process. Also, a cell instance sometimes has EM-violating metallization segments at different metallization layers, and one or more embodiments according to the present disclosure provide the flexibility in creating custom virtual must-join pins for each EM-violating metallization segment. In some embodiments, only modifying or changing the segments that are violating is more suitable for changes based on an ECO process at post-route stage compared to other fixing methods.

Accordingly, one or more embodiments according to the present disclosure correspond to a more flexible approach compared to the approach of via pillars or via ladders that requires more routing resources. Benefits and improvements associated with one or more embodiments according to the present disclosure include reduction in routing changes for signal EM fixing, reducing the impact on timing and DRC, and/or flexibility for fixing EM after routing based on an ECO process.

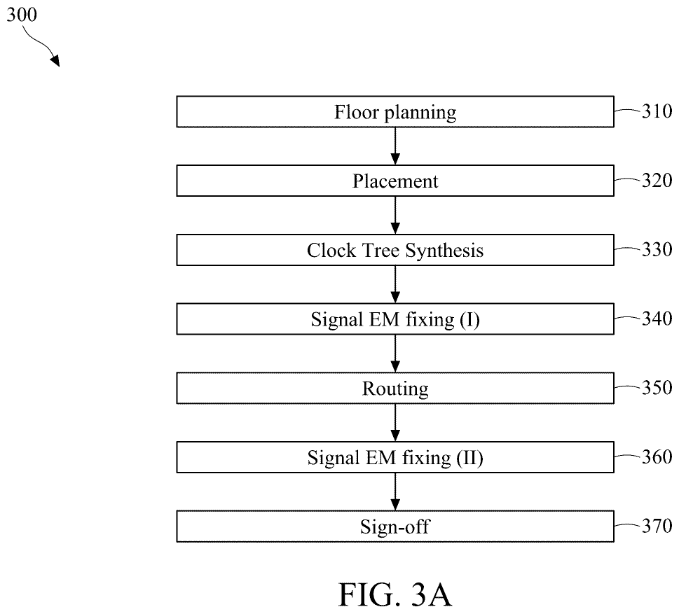

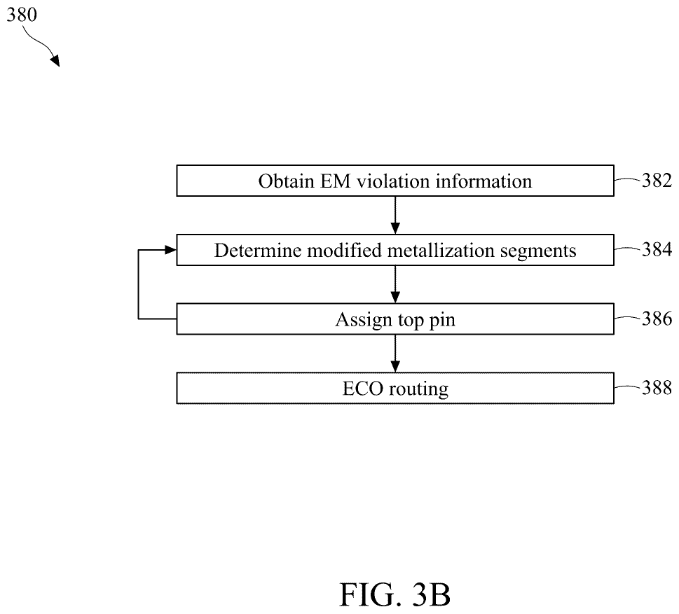

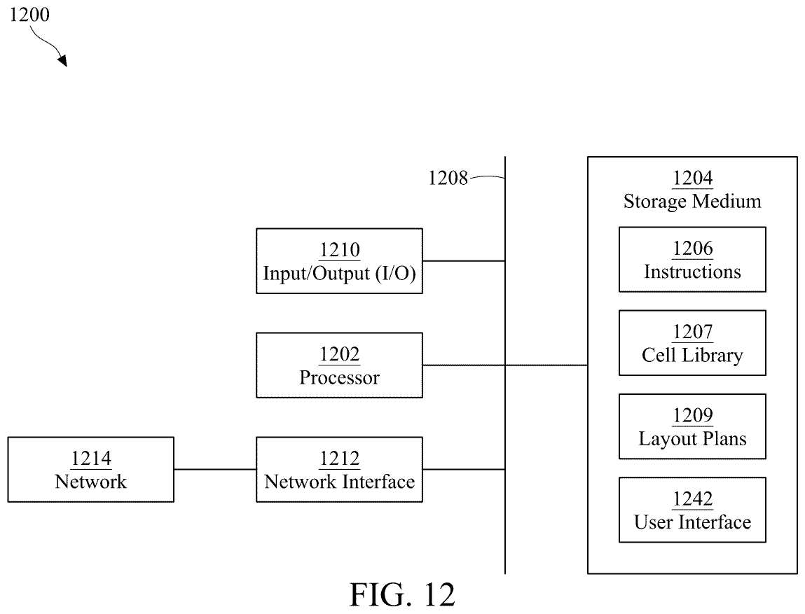

FIG. 3A is a flowchart of a process flow 300 of generating a layout plan for a semiconductor device, in accordance with some embodiments. In some embodiments, process flow 300 is based on an electronic design automation (EDA) system, such as the EDA system in FIG. 12, to carry out one or more operations in process flow 300. In some embodiments, process flow 300 is a simplified, non-limiting example, and various stages of process flow 300 are simplified or omitted in FIG. 3A. In FIG. 3A, process flow 300 includes stages 310-370.

At stage 310, a floor planning process is performed to create a floorplan for the semiconductor device by partitioning a layout area into functional blocks based on a circuit design of the semiconductor device. In some embodiments, the floor planning process at stage 310 includes identifying structures that can be placed close together, and allocating space for the structures to meet one or more design or performance criteria. In some embodiments, the floor planning process at stage 310 takes into account the macros, memory, and/or other intellectual property (IP) cores used in the layout plan. In some embodiments, the floor planning process at stage 310 also takes into account the corresponding placement of the circuit blocks used in the layout plan. In some embodiments, the floor planning process at stage 310 includes determining the input/output (IO) structure and aspect ratio of various features in the layout plan.

At stage 320, a placement process is performed to place the layout cells that are identified, mapped, and registered to various circuit blocks of the circuit design at specific locations in the layout plan.

At stage 330, a clock tree synthesis (CTS) process is performed based on a CTS tool that is configured to automatically design a clock tree for distributing a clock signal to a plurality of clocked devices such as flip-flops, registers, and/or latches. In some embodiments, the CTS tool creates metallization layout patterns indicative of the conductive structures (e.g., conductive lines in various metallization layers) that form the clock tree in a way that tries to equalize the distance the clock signal travels to each clocked device from an input terminal receiving the clock signal from an external source. In some embodiments, the CTS tool places buffers or amplifiers at branch points of the clock tree and sized as necessary to drive all of the clocked devices or buffers downstream of the branch point. In some embodiments, based on an estimate of the signal path delay in each branch of the clock tree, the CTS tool balances the clock tree by inserting additional buffers in selected branches of the clock tree to adjust the path delays within those branches to ensure that the clock tree will deliver each clock signal pulse to every clocked device at nearly the same time.

At stage 340, a signal EM fixing (I) process is performed based on a layout plan that corresponds to a result of the CTS process (e.g., at stage 330) prior to a routing process (e.g., at stage 350). In some embodiments, the signal EM fixing (I) process identifies signal-level EM violations in the layout plan and generates a modified layout plan to resolve the identified EM violations. The signal EM fixing (I) process is further illustrated based on the examples in FIGS. 3B-10B.

At stage 350, a routing process is performed to design conductive structures (e.g., based on various metallization layers and the corresponding via layers) electrically connecting various nets of the circuit design. In some embodiments, to a routing tool executing the routing process, each layout cell is recognizable based on one or more input pins and/or one or more output pins of the layout cell regardless of the detailed design of components of the layout cell.

At stage 360, a signal EM fixing (II) process is performed based on a layout plan that corresponds to a result of the routing process (e.g., at stage 350). In some embodiments, the signal EM fixing (II) process identifies signal-level EM violations in the layout plan and generates a modified layout plan to resolve the identified EM violations. In some embodiments, the signal EM fixing (I) process and the signal EM fixing (II) process are based on the same or similar processing flow. The signal EM fixing (II) process is further illustrated based on the examples in FIGS. 3B-10B.

At stage 370, a sign-off process is performed to verify the layout plan from stage 360 and to determine if the layout plan is suitable to be sent to a semiconductor manufacturer for manufacturing the semiconductor device. In some embodiments, the sign-off process includes performing a layout-versus-schematic (LVS) checking to compare a netlist generated from the layout plan against a netlist derived from the circuit design of the semiconductor device to ensure the correspondence relationship between the layout plan and the circuit design. In some embodiments, the sign-off process includes performing a design rule check (DRC) on the layout plan to ensure the layout plan is free of, for example, electrical issues and lithographic issues for manufacturing. In some embodiments, incremental fixing is performed at stage 370 to obtain a finalized layout plan that addresses the issues identified during the sign-off process.

FIG. 3B is a flowchart including various stages of a signal EM fixing process 380, in accordance with some embodiments. In some embodiments, signal EM fixing process 380 corresponds to the signal EM fixing (I) process at stage 340 or the signal EM fixing (II) process at stage 360 in FIG. 3A. In some embodiments, the flow chart in FIG. 3B highlights various stages of signal EM fixing process 380 as a non-limiting example. In FIG. 3B, signal EM fixing process 380 includes stages 382-388.

At stage 382, the signal EM violation information with regard to the present layout plan is obtained. In some embodiments, based on signal EM fixing process 380 corresponding to signal EM fixing (I) process at stage 340, the present layout plan corresponds to a result of a CTS process (e.g., stage 330 in FIG. 3B) prior to a routing process (e.g., stage 350 in FIG. 3B). In some embodiments, based on signal EM fixing process 380 corresponding to signal EM fixing (II) process at stage 360, the present layout plan corresponds to a result of the routing process (e.g., stage 350 in FIG. 3B). In some embodiments, the signal EM violation information is obtained based on performing an EM violation analysis on the present layout plan in view of the associated circuit design. In some embodiments, the EM violation analysis includes selecting a target circuit block, checking whether one or more nets of the target circuit block comply with one or more EM compliance criteria, and reporting the nets that fail to comply with the one or more EM compliance criteria (also referred to as EM violations in this disclosure) and/or the corresponding metallization segments (also referred to as EM-violating metallization segments in this disclosure) where the failures occur. In some embodiments, the one or more EM compliance criteria are based on multiple factors, including layout geometries, device temperatures, temperatures of conductive structures, and/or currents carried by conductive structures.

In some embodiments, the EM violation information indicates N signal-level EM violations associated with N nets in the present layout plan, and M[n] EM-violating metallization segments of an n-th one of the N signal-level EM violations. In some embodiments, N is a positive integer, and n is a positive integer ranging from 1 to N. Also, in some embodiments, M[n] is a positive integer.

At stage 384, two or more resulting metallization segments are determined for the modified layout plan based on an EM-violating metallization segment of a signal-level EM violation indicated in the EM violation information. The two or more resulting metallization segments and the EM-violating metallization segment are associated with a same net and correspond to the same metallization layer. In some embodiments, the two or more resulting metallization segments include one or more added metallization segments and the EM-violating metallization segment, where each one of the one or more added metallization segments has a size and a shape comparable to those of the EM-violating metallization segment and in parallel with the EM-violating metallization segment. In some embodiments, the two or more resulting metallization segments include the one or more added metallization segments and a shifted version of the EM-violating metallization segment.

In some embodiments, at stage 384, based on the EM-violating metallization segment being associated with a pin of a cell instance in the present layout plan and within a proximity window of the cell instance, the two or more resulting metallization segments are marked as a set of must-join pins imposing an electrical connection requirement thereto for an upper metallization layer. In some embodiments, a metallization layout pattern that includes the EM-violating metallization segment is configured to meet an electrical connection requirement for another set of must-join pins of a lower metallization layer. In some embodiments, the entirety of the metallization layout pattern is not indicated as the EM-violating metallization segment. As such, the one or more added metallization segments, based on the size and the shape of the EM-violating metallization segment, are not required to meet the electrical connection requirement for the other set of must-join pins of a lower metallization layer. Accordingly, the one or more added metallization segments are also referred to as “partial must-join pin(s)” in this disclosure.

At stage 386, based on the EM-violating metallization segment being associated with the pin of the cell instance in the present layout plan and corresponding to a highest metallization layer of the signal-level EM violation, and based on the corresponding two or more resulting metallization segments being marked as a set of must-join pins, the corresponding two or more resulting metallization segments are also assigned as a top pin of the cell instance in the modified layout plan. In some embodiments, stages 384 and 386 are repeatedly performed to address all EM-violating metallization segments of each EM violation of the EM violations indicated in the EM violation information.

At stage 388, an updated routing that modifies a present routing of the present layout plan is generated based on a set of resulting metallization segments from stages 384 and 386 for addressing the EM violations indicated in the EM violation information. In some embodiments, the updated routing is generated based on an engineering change order (ECO) process to incorporate localized modifications without incurring an overhaul of the routing.

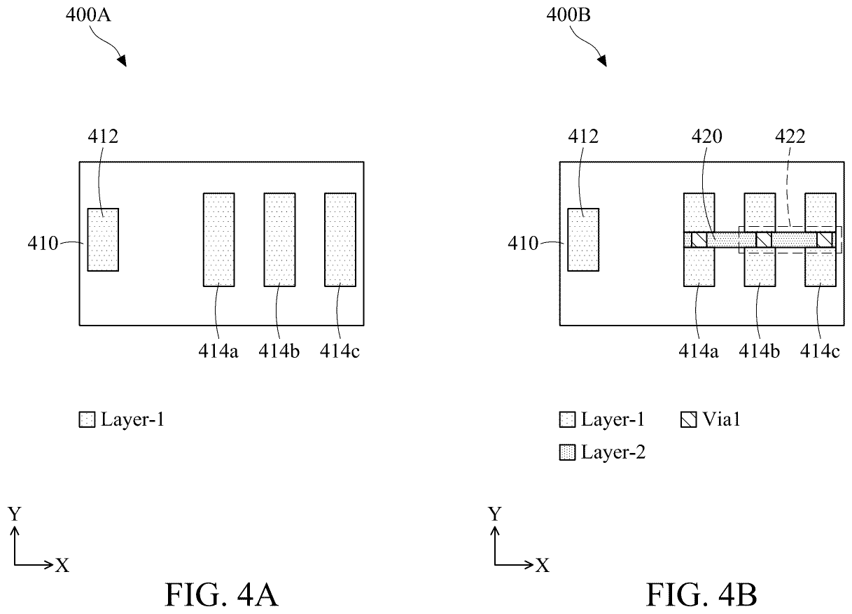

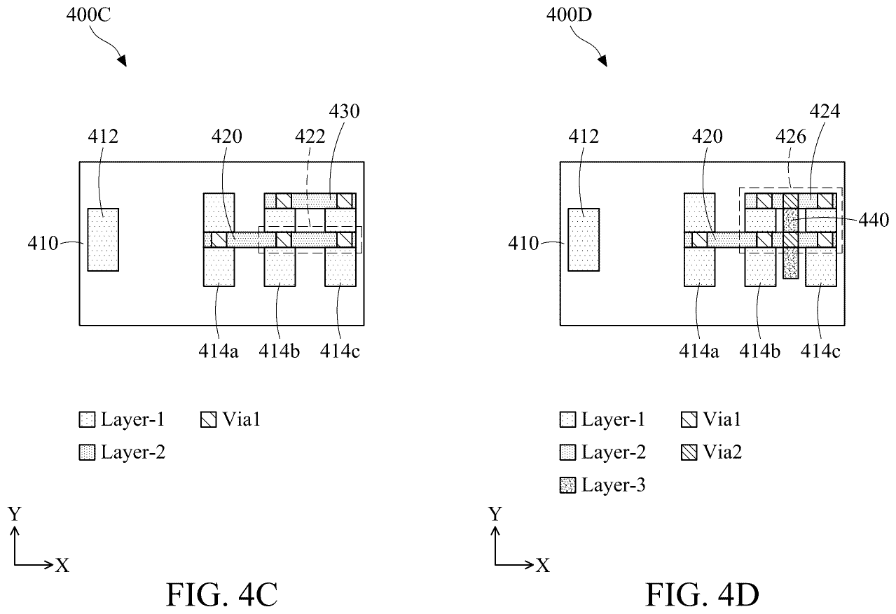

FIG. 4A is a plan view 400A that includes a cell instance 410 in a present layout plan for a semiconductor device, in accordance with some embodiments. In this example, cell instance 410 includes metallization layout patterns 412, 414a, 414b, and 414c indicative of conductive structures at a Layer-1 metallization layer (e.g., legend labeled as “Layer-1” in FIG. 4A). In some embodiments, Layer-1 metallization layer corresponds to a metallization layer in FIG. 2, such as M0 layer, M1 layer, or M2 layer in FIG. 2. In some embodiments, cell instance 410 corresponds to a layout cell indicative of a logic gate or a circuit block of the semiconductor device, and other details of cell instance 410 are omitted in FIG. 4A.

In this example, metallization layout pattern 412 is marked as an input pin of cell instance 410. In this example, metallization layout patterns 414a, 414b, and 414c are marked as a set of must-join pins and marked as an output pin of cell instance 410. In FIG. 4A, the input pin based on metallization layout pattern 412 and the output pin based on metallization layout patterns 414a, 414b, and 414c are top pins of cell instance 410. In some embodiments, a routing process is performed based on connecting various cell instances through the top pins of the cell instances, without considering the underlying configurations of the cell instances.

FIG. 4B is a plan view 400B that includes cell instance 410 with another metallization layout pattern 420 in the present layout plan, in accordance with some embodiments. Components and legends in FIG. 4B that are the same or similar to those in FIG. 4A are given the same reference numbers or reference labels, and the description thereof is thus simplified or omitted.

In FIG. 4B, based on a CTS process (e.g., stage 330 in FIG. 3A) or a routing process (e.g., stage 350 in FIG. 3A), metallization layout pattern 420 indicative of a conductive structure at a Layer-2 metallization layer (e.g., legend labeled as “Layer-2” in FIG. 4B) and corresponding via patterns (not labeled) indicative of via structures at Vial layer (e.g., legend labeled as “Vial” in FIG. 4B) are formed. In this example, metallization layout pattern 420 is indicative of a Layer-2 conductive structure extending along a first horizontal direction (e.g., the X direction), metallization layout patterns 414a, 414b, and 414c are indicative of Layer-1 conductive structures extending along a second horizontal direction (e.g., the Y direction), and the via patterns of Vial layer are indicative of via structures configured to electrically couple the Layer-2 conductive structure (indicated by metallization layout pattern 420) to the Layer-1 conductive structures (indicated by metallization layout patterns 414a, 414b, and 414c). Moreover, in this example, the EM violation information (e.g., from stage 382 in FIG. 3B) indicates a signal-level EM violation associated with a net that corresponds to metallization layout patterns 414a, 414b, and 414c. The EM violation information further indicates that the signal-level EM violation includes an EM-violating metallization segment (e.g., a portion of metallization layout pattern 420 within the dashed box 422 or simply referred to as EM-violating metallization segment 422 in this disclosure).

FIG. 4C is a plan view 400C that includes cell instance 410 with an added metallization layout pattern 430 in a modified layout plan, in accordance with some embodiments. Components and legends in FIG. 4C that are the same or similar to those in FIG. 4B are given the same reference numbers or reference labels, and the description thereof is thus simplified or omitted.

In FIG. 4C, to address the EM violation corresponding to EM-violating metallization segment 422, added metallization layout pattern 430 is created to share the current loading of the EM-violating metallization segment 422. In this example, the added metallization segment (e.g., added metallization layout pattern 430) and EM-violating metallization segment 422 correspond to a same metallization layer of the semiconductor device (e.g., Layer-1 metallization layer). In FIG. 4C, the added metallization segment has a size and a shape comparable to those of EM-violating metallization segment 422. In this example, the added metallization segment and EM-violating metallization segment 422 are parallel along the first horizontal direction (e.g., the X direction) and are aligned along the second horizontal direction (e.g., the Y direction).

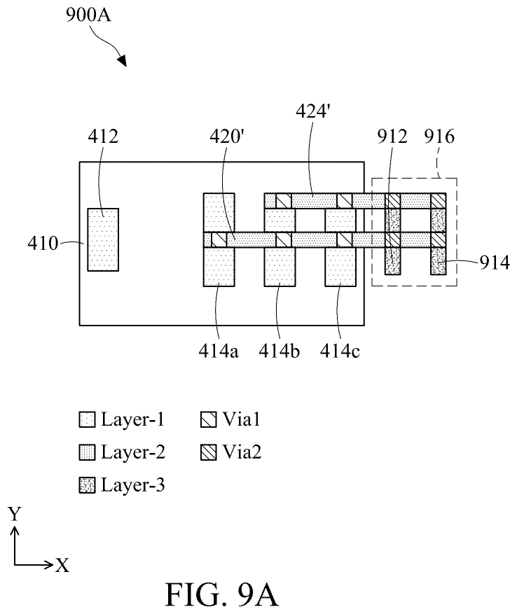

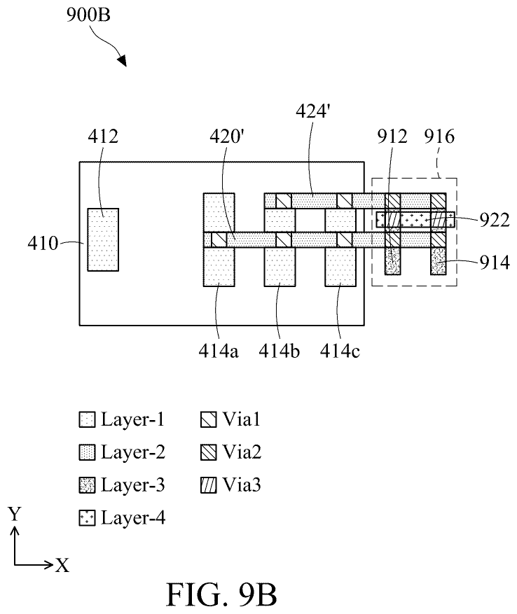

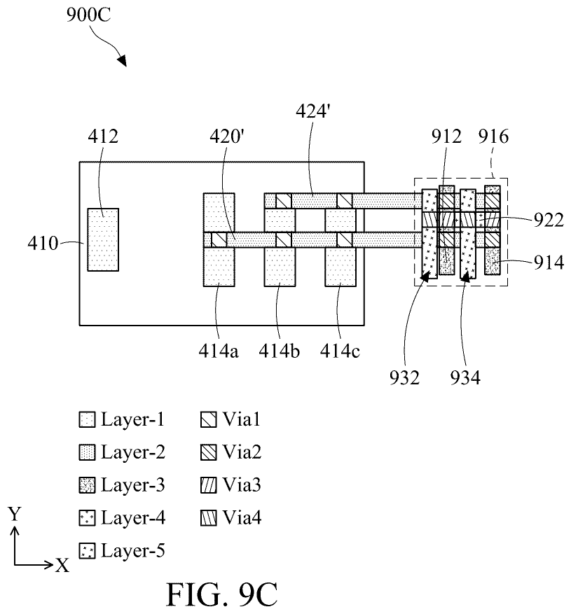

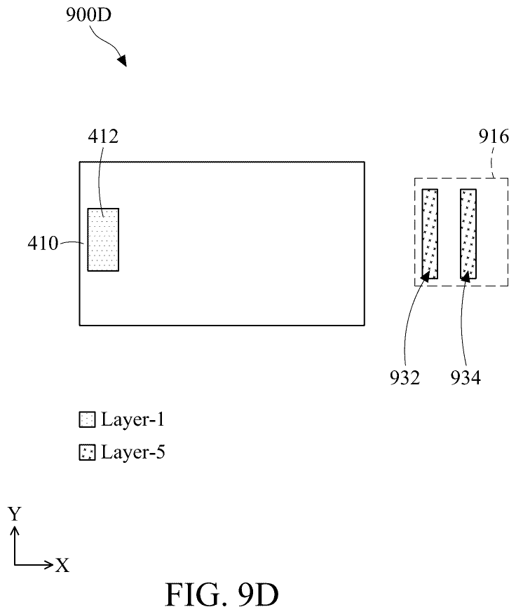

In this example, only one added metallization segment (e.g., added metallization layout pattern 430) is created. In some embodiments, one or more added metallization segments are created in order to resolve the EM violation associated with EM-violating metallization segment 422. Also, in this example, the added metallization segment (e.g., added metallization layout pattern 430) is created inside the cell instance 410 and the EM-violating metallization segment 422 is used in the modified layout plan without modification. In some other embodiments, the EM-violating metallization segment 422 is extended and/or shifted, and the added metallization segment (e.g., added metallization layout pattern 430) is created based on the extended/shifted counterpart of EM-violating metallization segment 422. In some embodiments, the added metallization segment and the extended/shifted counterpart of EM-violating metallization segment 422 are arranged outside the corresponding cell instance, as further illustrated in the examples in FIGS. 9A-9D.

In some embodiments, additional via patterns (not labeled) of Vial layer are added, where the additional via patterns are indicative of via structures configured to electrically couple a Layer-2 conductive structure indicated by added metallization layout pattern 430 to the Layer-1 conductive structures indicated by metallization layout patterns 414b and 414c. Also, the added metallization segment (e.g., added metallization layout pattern 430) and EM-violating metallization segment 422 (not the entire metallization layout pattern 420) are marked as a set of must-join pins. Therefore, the conductive structures indicated by the added metallization segment (e.g., added metallization layout pattern 430) and EM-violating metallization segment 422 will be electrically coupled together though another conductive structure at an upper metallization layer (e.g., a Layer-3 metallization layer). Also, in this example, EM-violating metallization segment 422 from the present layout plan is usable to meet the electrical connection requirement of the set of must-join pins based on metallization layout patterns 414a, 414b, and 414c. In this example, on the other hand, the added metallization segment (e.g., added metallization layout pattern 430) is not required to be used to meet the electrical connection requirement of the set of must-join pins based on metallization layout patterns 414a, 414b, and 414c. Accordingly, the added metallization segment (e.g., added metallization layout pattern 430) is also referred to as a partial must-join pin.

FIG. 4D is a plan view 400D that includes cell instance 410 with a metallization layout pattern 440 in the modified layout plan, in accordance with some embodiments. Components and legends in FIG. 4D that are the same or similar to those in FIG. 4C are given the same reference numbers or reference labels, and the description thereof is thus simplified or omitted.

In FIG. 4D, the added metallization segment (e.g., added metallization layout pattern 430) and EM-violating metallization segment 422 are marked as a set of must-join pins, and define a connection window 426. In some embodiments, the conductive structures indicated by the added metallization segment and EM-violating metallization segment 422 are to be electrically coupled through an upper layer conductive structure within connection window 426. In this regard, to meet the electrical connection requirement of the added metallization segment and EM-violating metallization segment 422 being marked as a set of must-join pins, metallization layout pattern 440 indicative of the upper layer conductive structure at a Layer-3 metallization layer (e.g., legend labeled as “Layer-3” in FIG. 4D) and corresponding via patterns (not labeled) indicative of via structures at Via2 layer (e.g., legend labeled as “Via2” in FIG. 4D) are included in plan view 400D.

In some embodiments, metallization layout pattern 440 corresponds to an original metallization layout pattern of Layer-3 metallization layer in the present layout plan and is kept in the modified layout plan. In some embodiments, metallization layout pattern 440 corresponds to a modified or extended counterpart of an original metallization layout pattern of Layer-3 metallization layer in the present layout plan. In some embodiments, metallization layout pattern 440 is added to the modified layout plan to meet the electrical connection requirement of the added metallization segment and EM-violating metallization segment 422 of Layer-2 metallization layer being marked as a set of must-join pins.

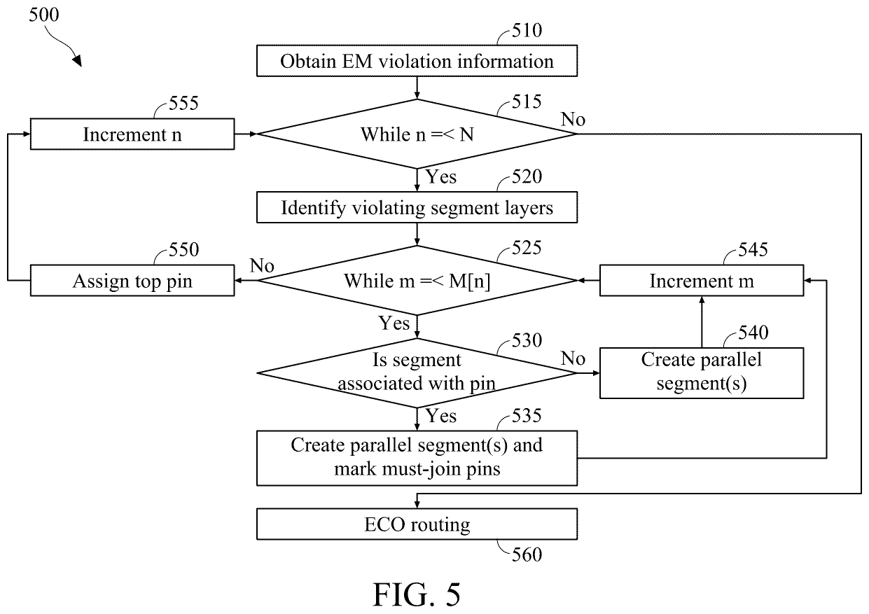

FIG. 5 is a flowchart of a signal EM fixing process 500 considering one or more EM violations, in accordance with some embodiments. In some embodiments, signal EM fixing process 500 describes additional details of signal EM fixing process 380 in FIG. 3B. In FIG. 5, signal EM fixing process 500 includes stages 510-560. In some embodiments, stage 510 corresponds to stage 382 in FIG. 3B; stages 515-535 correspond to stage 384 in FIG. 3B; stage 550 corresponds to stage 386 in FIG. 3B; and stage 560 corresponds to stage 388 in FIG. 3B.

At stage 510, the EM violation information regarding a present layout plan is obtained as described in FIG. 3B. In some embodiments, the EM violation information indicates N signal-level EM violations associated with N nets in the present layout plan, and M[n] EM-violating metallization segments of an n-th one of the N signal-level EM violations. In some embodiments, N is a positive integer, n is a positive integer ranging from 1 to N, and M[n] is a positive integer.

For example, the EM violation information indicates 3 signal-level EM violations associated with 3 nets (e.g., N=3). The EM violation information further indicates that the first EM violation (e.g., n=1) includes 3 EM-violating metallization segments (M[1]=3), the second EM violation (e.g., n=2) includes 2 EM-violating metallization segments (M[2]=2), and the third EM violation (e.g., n=2) includes 2 EM-violating metallization segments (M[3]=2). In some embodiments, the EM violation information further indicates the metallization layers associated with the corresponding EM-violating metallization segments.

Prior to stage 515, the index n is set to 1 in order to initiate performing N EM fixing operations for the N EM violations one by one. At stage 515, whether the index n is equal to or less than N is determined. Based on index n is determined as equal to or less than N, the process proceeds to stage 520 to perform a corresponding EM fixing operation for the n-th EM violation. Based on index n is determined as greater than N, all N EM violations have been processed by the corresponding EM fixing operations, and the process proceeds to stage 560.

At stage 520, the M[n] EM-violating metallization segments of the n-th EM violation and the corresponding metallization layers are identified. In this example, the M[n] EM-violating metallization segments are arranged (and to be processed accordingly) one by one based on an order of from a lower metallization layer to an upper metallization layer. Prior to stage 525, the index m is set to 1. The process proceeds to stage 525.

At stage 525, whether the index m is equal to or less than M[n] is determined. Based on index m being determined as equal to or less than M[n], the process proceeds to stage 530 for processing each one of the M[n] EM-violating metallization segments of the n-th signal-level EM violation. Based on index m being determined as greater than M[n], all M[n] EM-violating metallization segments have been processed, and the process proceeds to stage 550.

At stage 530, for the m-th EM-violating metallization segment, it is determined if the m-th EM-violating metallization segment is associated with a pin of a cell instance in the present layout plan and within a proximity window of the cell instance. Based on the m-th EM-violating metallization segment being determined as associated with the pin of the cell instance and within the proximity window, the process proceeds to stage 535. Otherwise, the process proceeds to stage 540.

At stage 535, one or more added metallization segments are created based on the m-th EM-violating metallization segment, where the one or more added metallization segments and the m-th EM-violating metallization segment corresponds to a same metallization layer of the semiconductor device. In some embodiments, the one or more added metallization segments and the m-th EM-violating metallization segment (or an extended or shifted counterpart of the m-th EM-violating metallization segment as further illustrated based on the examples in FIGS. 9A-9D) are parallel along a first horizontal direction and aligned along a second horizontal direction. At stage 535, two or more resulting metallization segments are determined based on the one or more added metallization segments and the m-th EM-violating metallization segment (or an extended or shifted counterpart of the m-th EM-violating metallization segment). Moreover, at stage 535, the two or more added metallization segments are marked as a set of must-join pins.

At stage 540, one or more added metallization segments are created, and the two or more resulting metallization segments are determined in a manner similar to the operations at stage 535. However, at stage 540, the two or more resulting metallization segments are not marked as a set of must-join pins.

After stage 535 and 540, the process proceeds to stage 545, where index m is incremented by one. Afterwards, the process proceeds to stage 525 for processing the next one of the M[n] EM-violating metallization segments.

At stage 550, the index m is greater than M[n] indicating that all M[n] EM-violating metallization segments of the n-th signal level EM violation have been processed. At stage 550, based on the M-th violating metallization segment of the n-th signal-level EM violation being associated with a pin of a cell instance in the present layout plan and corresponding to a highest metallization layer of the n-th signal-level EM violation, and based on the corresponding two or more resulting metallization segments being marked as a set of must-join pins, the corresponding two or more resulting metallization segments based on the M-th violating metallization segment are assigned as a top pin of the cell instance. After stage 550, the process proceeds to stage 555, where the index n is incremented by one. Afterwards, the process proceeds to stage 515.

At stage 515, once the index n exceeds N, all N signal level EM violations have been processed, and the process proceeds to stage 560. At stage 560, an updated routing that modifies a present routing of the present layout plan is generated based on the set of resulting metallization segments determined based on stages 515-555. In some embodiments, the updated routing is generated based on an ECO process

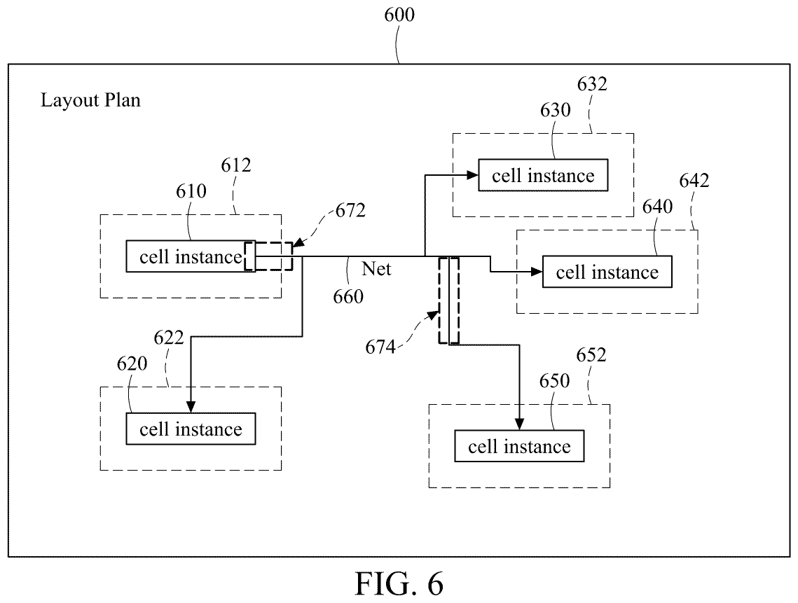

FIG. 6 is a simplified plan view of a layout plan 600 for a semiconductor device, in accordance with some embodiments. Various components of layout plan 600 are simplified or omitted in FIG. 6. In this example, layout plan 600 includes cell instances 610, 620, 630, 640, and 650. Also, layout plan 600 includes a set of conductive paths 660 that corresponds to a net of the semiconductor device.

In this example, for the purposes of performing one or more signal EM fixing processes, the corresponding proximity windows 612, 622, 632, 642, and 652 are defined for corresponding cell instances 610, 620, 630, 640, and 650. In some embodiments, each one of the proximity windows 612, 622, 632, 642, and 652 is determinable based on a first predetermined distance along a cell height direction (e.g., the Y direction) to a boundary of the corresponding cell instance, a second predetermined distance along a cell width direction (e.g., the X direction) to the boundary of the corresponding cell instance, a set of coordinates based on a user input (e.g., a user-defined window), a set of routing rules, an associated metallization layer (e.g., different proximity windows for different metallization layers), or a combination thereof. In some embodiments, the first predetermined distance corresponds to one or two standard cell heights of the layout plan above or below the corresponding cell instance. In some embodiments, the second predetermined distance corresponds to three to five contacted poly pitches (CPPs, corresponding to the pitch between two adjacent gate structures) of the layout plan.

In FIG. 6, as a non-limiting example, an EM-violating metallization segments within a first area 672 and an EM-violating metallization segment within a second area 674 are indicated by the EM violation information. In some embodiments based on stage 535 in FIG. 5, for a first scenario corresponding to an EM-violating metallization segment within a proximity window of a cell instance (e.g., in area 672 within proximity window 612 of cell instance 610), one or more added metallization segments are created, and the one or more added metallization segments and the corresponding EM-violating metallization segment (or extended or shifted counterpart of the EM-violating metallization segment) are marked as a set of must-join pins. In some embodiments, according to the first scenario, the conductive structures indicated by the one or more added metallization segments and the corresponding EM-violating metallization segment are electrically coupled together by at least one conductive structure at a metallization layer immediately below and at least one conductive structure at a metallization layer immediately above the metallization layer to which the one or more added metallization segments and the corresponding EM-violating metallization segment belong.

Also, in some embodiments based on stage 540 in FIG. 5, for a second scenario corresponding to an EM-violating metallization segment outside of any proximity window (e.g., in area 674), one or more added metallization segments are created, and the added metallization segments and the corresponding EM-violating metallization segment are not marked as a set of must-join pins. In some embodiments, according to the second scenario, the conductive structures indicated by the one or more added metallization segments and the corresponding EM-violating metallization segment are electrically coupled together by at least one conductive structure at a metallization layer immediately below, but not necessarily electrically coupled together by a conductive structure at a metallization layer immediately above the metallization layer to which the one or more added metallization segments and the corresponding EM-violating metallization segment belong.

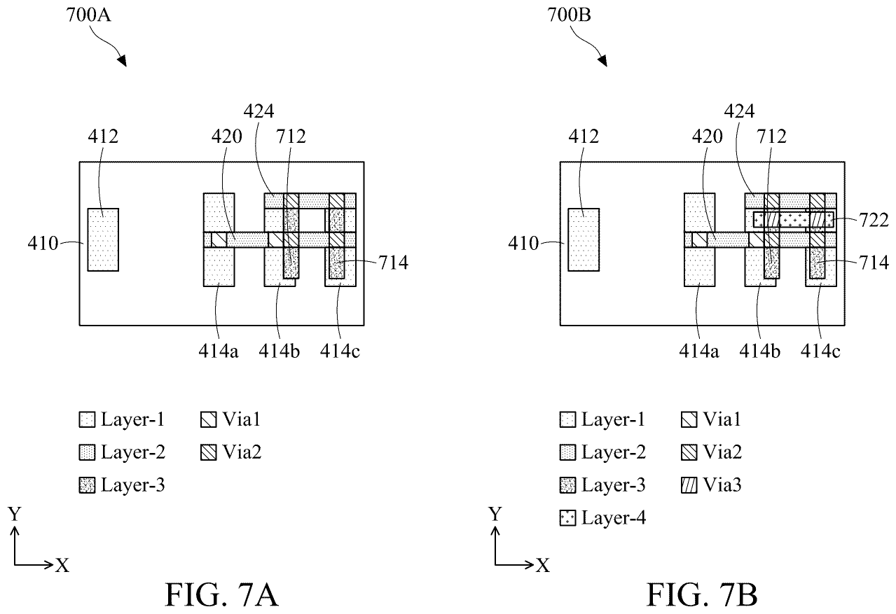

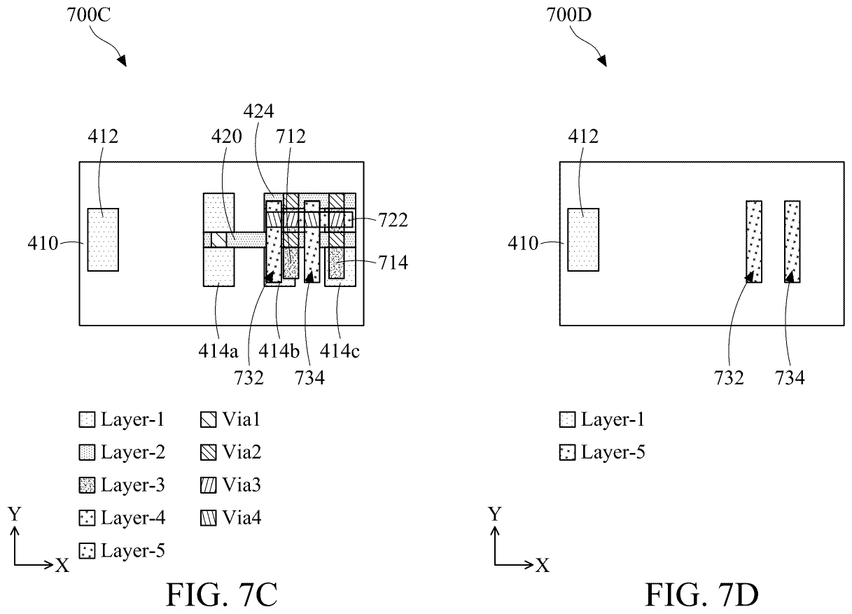

FIGS. 7A-7D are plan views of a portion of a layout plan at various stages of a signal EM fixing process based on a first example, in accordance with some embodiments. In this example, the signal EM fixing process is performed based on the signal EM fixing process 500 in FIG. 5. In some embodiments, the signal EM fixing process starts with obtaining a present layout plan in a manner similar to the example in FIG. 4A, identifying EM-violating metallization segment 422 at Layer-2 metallization layer in a manner similar to the example in FIG. 4B, and determining a set of modified metallization segments (including EM-violating metallization segment 422 and added metallization segment 424) that are marked as a set of must-join pins in a manner similar to the example in FIG. 4C.

FIG. 7A is a plan view 700A based on the components in plan view 400C, further including an EM-violating metallization segment 712 and an added metallization segment 714 at a Layer-3 metallization layer (e.g., legend labeled as “Layer-3” in FIG. 7A) and corresponding via patterns (not labeled) at Via2 layer (e.g., legend labeled as “Via2” in FIG. 7A). Components and legends in FIG. 7A that are the same or similar to those in FIG. 4C are given the same reference numbers or reference labels, and the description thereof is thus simplified or omitted.

In some embodiments, after addressing the EM-violating metallization segment corresponding to metallization layout pattern 420 at Layer-2 metallization layer, based on proceeding from stage 535 to stage 545 and then stage 525 in FIG. 5, the next EM-violating metallization segment (e.g., EM-violating metallization segment 712) at an upper metallization layer (e.g., Layer-3 metallization layer) is processed based on stage 530 and stage 535 in FIG. 5. As a result, added metallization segment 714 is created, and EM-violating metallization segment 712 and added metallization segment 714 are marked as a set of must-join pins for the next metallization layer.

FIG. 7B is a plan view 700B based on the components in plan view 700A, further including a metallization layout pattern 722 at a Layer-4 metallization layer (e.g., legend labeled as “Layer-4” in FIG. 7B) and corresponding via patterns (not labeled) at Via3 layer (e.g., legend labeled as “Via3” in FIG. 7B). Components and legends in FIG. 7B that are the same or similar to those in FIG. 7A are given the same reference numbers or reference labels, and the description thereof is thus simplified or omitted.

In this example, after addressing EM-violating metallization segment 712 at Layer-3 metallization layer, metallization layout pattern 722 at Layer-4 metallization layer is not indicated as an EM-violating metallization segment. Accordingly, no added metallization segment is created based on metallization layout pattern 722. In some embodiments, the size and shape of metallization layout pattern 722 at Layer-4 metallization layer are modified and the corresponding via patterns at Via3 layer are added in order to meet the connection requirement of the set of must-join pins based on EM-violating metallization segment 712 and added metallization segment 714.

FIG. 7C is a plan view 700C based on the components in plan view 700B, further including an EM-violating metallization segment 732 and an added metallization segment 734 at a Layer-5 metallization layer (e.g., legend labeled as “Layer-5” in FIG. 7C) and corresponding via patterns (not labeled) at Via4 layer (e.g., legend labeled as “Via4” in FIG. 7C). Components and legends in FIG. 7C that are the same or similar to those in FIG. 7B are given the same reference numbers or reference labels, and the description thereof is thus simplified or omitted.

In this example, after addressing EM-violating metallization segment 712 at Layer-3 metallization layer by creating added metallization segment 714 at Layer-3 metallization layer and modifying/keeping metallization layout pattern 722 at Layer-4 metallization layer, the next EM-violating metallization segment (e.g., EM-violating metallization segment 732) is at an upper metallization layer (e.g., Layer-5 metallization layer) and to be processed based on stage 530 and stage 535 in FIG. 5. As a result, added metallization segment 734 is created, and EM-violating metallization segment 732 and added metallization segment 734 are marked as a set of must-join pins for the next metallization layer.

FIG. 7D is a simplified plan view 700D based on the components in plan view 700C, including only the boundary of cell instance 410 and top pins of cell instance 410. Components and legends in FIG. 7D that are the same or similar to those in FIG. 7C are given the same reference numbers or reference labels, and the description thereof is thus simplified or omitted.

In this example, EM-violating metallization segment 732 at Layer-5 metallization layer is the EM-violating metallization segment of the EM violation at the highest metallization layer. As described in stage 550 in FIG. 5, based on EM-violating metallization segment 732 being associated with a pin (e.g., an output pin corresponding to metallization layout patterns 414a, 414b, and 414c) of cell instance 410 in the present layout plan and corresponding to the highest metallization layer of the signal-level EM violation, and based on EM-violating metallization segment 732 and added metallization segment 734 being marked as a set of must-join pins, EM-violating metallization segment 732 and added metallization segment 734 are assigned as a top pin (e.g., an output pin) of cell instance 410 in the modified layout plan in place of the pin based on metallization layout patterns 414a, 414b, and 414c. Also, metallization layout pattern 412 corresponds to an input pin of cell instance 410 in the present layout plan and is kept as an input pin of cell instance 410 in the modified layout plan.

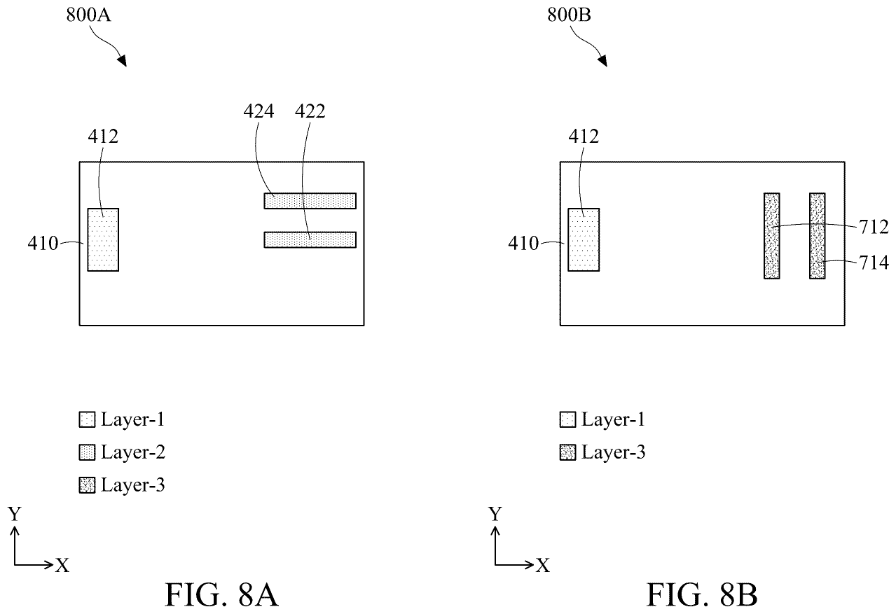

FIG. 8A is a plan view 800A of a cell instance example with reassigned top pins, in accordance with some embodiments. Plan view 800A is a simplified plan view based on the components in plan view 400C, including only the boundary of cell instance 410 and the top pins of cell instance 410. Components and legends in FIG. 8A that are the same or similar to those in FIG. 4C are given the same reference numbers or reference labels, and the description thereof is thus simplified or omitted.

In this example, EM-violating metallization segment 422 at Layer-2 metallization layer is already the EM-violating metallization segment of the EM violation at the highest metallization layer. As described in stage 550 in FIG. 5, based on EM-violating metallization segment 422 being associated with a pin (e.g., an output pin corresponding to metallization layout patterns 414a, 414b, and 414c) of cell instance 410 in the present layout plan and corresponding to the highest metallization layer of the signal-level EM violation, and based on EM-violating metallization segment 422 and added metallization segment 424 being marked as a set of must-join pins, EM-violating metallization segment 422 and added metallization segment 424 are assigned as a top pin (e.g., an output pin) of cell instance 410 in the modified layout plan in place of the pin based on metallization layout patterns 414a, 414b, and 414c. Also, metallization layout pattern 412 corresponds to an input pin of cell instance 410 in the present layout plan and is kept as an input pin of cell instance 410 in the modified layout plan.

FIG. 8B is a plan view 800B of a cell instance example with reassigned top pins, in accordance with some embodiments. Plan view 800B is a simplified plan view based on the components in plan view 700A, including only the boundary of cell instance 410 and the top pins of cell instance 410. Components and legends in FIG. 8B that are the same or similar to those in FIG. 7A are given the same reference numbers or reference labels, and the description thereof is thus simplified or omitted.

In this example, EM-violating metallization segment 712 at Layer-3 metallization layer is the EM-violating metallization segment of the EM violation at the highest metallization layer. As described in stage 550 in FIG. 5, based on EM-violating metallization segment 712 being associated with a pin (e.g., an output pin corresponding to metallization layout patterns 414a, 414b, and 414c) of cell instance 410 in the present layout plan and corresponding to the highest metallization layer of the signal-level EM violation, and based on EM-violating metallization segment 712 and added metallization segment 714 being marked as a set of must-join pins, EM-violating metallization segment 712 and added metallization segment 714 are assigned as a top pin (e.g., an output pin) of cell instance 410 in the modified layout plan in place of the pin based on metallization layout patterns 414a, 414b, and 414c. Also, metallization layout pattern 412 corresponds to an input pin of cell instance 410 in the present layout plan and is still kept as an input pin of cell instance 410 in the modified layout plan.

FIGS. 9A-9D are plan views of a portion of a layout plan at various stages of a signal EM fixing process based on a second example, in accordance with some embodiments. In this example, the signal EM fixing process is performed based on the signal EM fixing process 500 in FIG. 5. In some embodiments, the signal EM fixing process starts with obtaining a present layout plan in a manner similar to the example in FIG. 4A, identifying EM-violating metallization segment 422 at Layer-2 metallization layer in a manner similar to the example in FIG. 4B, and determining a set of modified metallization segments (including EM-violating metallization segment 422 and added metallization segment 424) that are marked as a set of must-join pins in a manner similar to the example in FIG. 4C.

FIG. 9A is a plan view 900A based on the components in plan view 400C, further including a shifted EM-violating metallization segment 912 and an added metallization segment 914 at a Layer-3 metallization layer (e.g., legend labeled as “Layer-3” in FIG. 9A) and corresponding via patterns (not labeled) at Via2 layer (e.g., legend labeled as “Via2” in FIG. 9A) in a connection window 916. Components and legends in FIG. 9A that are the same or similar to those in FIG. 4C are given the same reference numbers or reference labels, and the description thereof is thus simplified or omitted.

In some embodiments, after addressing the EM-violating metallization segment corresponding to metallization layout pattern 420 at Layer-2 metallization layer, based on proceeding from stage 535 to stage 545 and then stage 525 in FIG. 5, the next EM-violating metallization segment (e.g., EM-violating metallization segment 712 in FIG. 7A, not shown in FIG. 9A) at an upper metallization layer (e.g., Layer-3 metallization layer) is processed based on stage 530 and stage 535 in FIG. 5. However, compared to the example in FIG. 7A, there may not be sufficient routing resources for creating added metallization segment 714 adjacent to EM-violating metallization segment 712 as in the example of FIG. 7A. To ensure sufficient routing resources for creating added metallization segments, EM-violating metallization segment 712 is shifted to become shifted EM-violating metallization segment 912, and an added metallization segment 914 is created based on shifted EM-violating metallization segment 912 in a manner similar to the creation of added metallization segment 714. In FIG. 9A as a non-limiting example, shifted EM-violating metallization segment 912 and added metallization segment 914 are marked as a set of must-join pins and define a connection window 916 for a next metallization layer. In some embodiments, shifted EM-violating metallization segment 912, added metallization segment 914, and connection window 916 are outside cell instance 410.

In some embodiments, the metallization layout pattern 420 and the added metallization segment 424 are also extended to become extended layout patterns 420′ and 424′, such that shifted EM-violating metallization segment 912 and added metallization segment 914 overlap extended layout patterns 420′ and 424′ in connection window 916. In some embodiments, via patterns at Via 2 layer are created in connection window 916 indicative of via structures connecting the conductive structures indicated by extended layout patterns 420′ and 424′, shifted EM-violating metallization segment 912, and added metallization segment 914.

FIG. 9B is a plan view 900B based on the components in plan view 900A, further including a metallization layout pattern 922 at a Layer-4 metallization layer (e.g., legend labeled as “Layer-4” in FIG. 9B) and corresponding via patterns (not labeled) at Via3 layer (e.g., legend labeled as “Via3” in FIG. 9B). Components and legends in FIG. 9B that are the same or similar to those in FIG. 9A are given the same reference numbers or reference labels, and the description thereof is thus simplified or omitted.

In this example, after addressing EM-violating metallization segment 712 at Layer-3 metallization layer, based on shifted EM-violating metallization segment 912 and added metallization segment 914 in connection window 916, metallization layout pattern 722 (in FIG. 7B, not shown in FIG. 9B) at Layer-4 metallization layer is also shifted to connection window 916 and becomes EM-violating metallization segment 912. In this example, metallization layout pattern 722 (and therefore metallization layout pattern 922 as well) is not indicated as an EM-violating metallization segment. Accordingly, no added metallization segment is created based on metallization layout pattern 922. In some embodiments, the size and shape of metallization layout pattern 922 at Layer-4 metallization layer are modified and the corresponding via patterns at Via3 layer are added in order to meet the connection requirement of the set of must-join pins based on shifted EM-violating metallization segment 912 and added metallization segment 914.

FIG. 9C is a plan view 900C based on the components in plan view 900B, further including an EM-violating metallization segment 932 and an added metallization segment 934 at a Layer-5 metallization layer (e.g., legend labeled as “Layer-5” in FIG. 9C) and corresponding via patterns (not labeled) at Via4 layer (e.g., legend labeled as “Via4” in FIG. 9C). Components and legends in FIG. 9C that are the same or similar to those in FIG. 9B are given the same reference numbers or reference labels, and the description thereof is thus simplified or omitted.

In this example, after addressing shifted EM-violating metallization segment 912 at Layer-3 metallization layer by creating added metallization segment 914 at Layer-3 metallization layer and creating shifted metallization layout pattern 922 at Layer-4 metallization layer in connection window 916, EM-violating metallization segment 732 (in FIG. 7C, not shown in FIG. 9C) at Layer-5 metallization layer is also shifted to connection window 916 and becomes EM-violating metallization segment 932. In this example, EM-violating metallization segment 732 (and the property carried over to EM-violating metallization segment 932) is processed based on stage 530 and stage 535 in FIG. 5. As a result, added metallization segment 934 is created, and shifted EM-violating metallization segment 932 and added metallization segment 934 are marked as a set of must-join pins for next metallization layer.

FIG. 9D is a simplified plan view 900D based on the components in plan view 900C, including only the boundary of cell instance 410 and top pins of cell instance 410. Components and legends in FIG. 9D that are the same or similar to those in FIG. 9C are given the same reference numbers or reference labels, and the description thereof is thus simplified or omitted.

In this example, EM-violating metallization segment 932 at Layer-5 metallization layer is the EM-violating metallization segment of the EM violation at the highest metallization layer. As described in stage 550 in FIG. 5, based on EM-violating metallization segment 932 being associated with a pin (e.g., an output pin corresponding to metallization layout patterns 414a, 414b, and 414c) of cell instance 410 in the present layout plan and corresponding to the highest metallization layer of the signal-level EM violation, and based on EM-violating metallization segment 932 and added metallization segment 934 being marked as a set of must-join pins, EM-violating metallization segment 932 and added metallization segment 934 are assigned as a top pin (e.g., an output pin) of cell instance 410 in the modified layout plan in place of the pin based on metallization layout patterns 414a, 414b, and 414c. Also, metallization layout pattern 412 corresponds to an input pin of cell instance 410 in the present layout plan and is kept as an input pin of cell instance 410 in the modified layout plan.

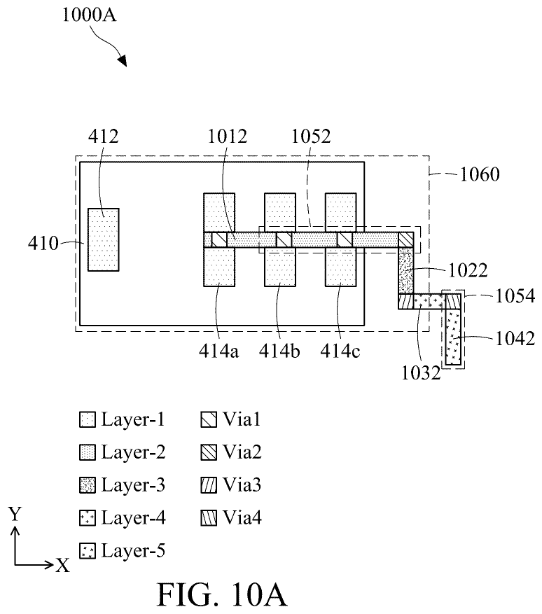

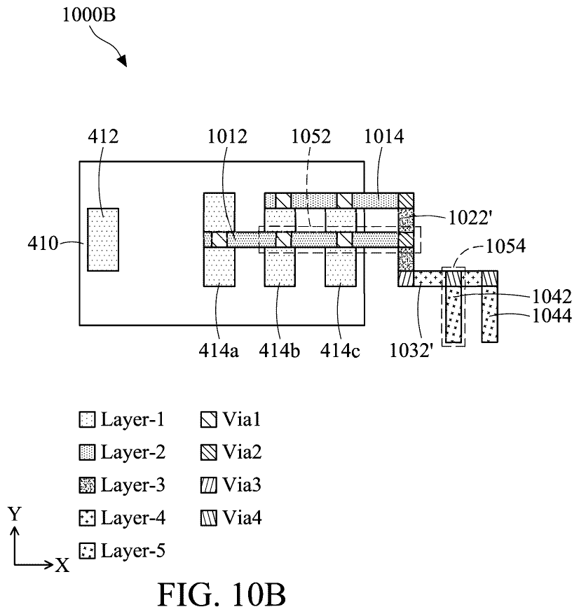

FIG. 10A is a plan view 1000A that includes a cell instance (e.g., cell instance 410 in FIG. 4A) in a present layout plan for a semiconductor device and one or more metallization layout patterns at various metallization layers, in accordance with some embodiments. Components and legends in FIG. 10A that are the same or similar to those in FIG. 4A are given the same reference numbers or reference labels, and the description thereof is thus simplified or omitted.

In this example, cell instance 410 includes metallization layout patterns 412, 414a, 414b, and 414c at a Layer-1 metallization layer (e.g., legend labeled as “Layer-1” in FIG. 10A), as similarly described in the example of FIG. 4A. Moreover, plan view 1000A includes a metallization layout pattern 1012 at a Layer-2 metallization layer (e.g., legend labeled as “Layer-2” in FIG. 10A), a metallization layout pattern 1022 at a Layer-3 metallization layer (e.g., legend labeled as “Layer-3” in FIG. 10A), a metallization layout pattern 1032 at a Layer-4 metallization layer (e.g., legend labeled as “Layer-4” in FIG. 10A), and a metallization layout pattern 1042 at a Layer-5 metallization layer (e.g., legend labeled as “Layer-5” in FIG. 10A).

In FIG. 10A, metallization layout pattern 1012 extends along a first horizontal direction (e.g., the X direction), overlaps metallization layout patterns 414a, 414b, and 414c, and extends outside the boundary of cell instance 410. Plan view 1000A further includes three via patterns (not labeled) at Vial layer (e.g., legend labeled as “Vial” in FIG. 10A) that are indicative of via structures electrically connecting the conductive structures indicated by metallization layout patterns 414a, 414b, and 414c and metallization layout pattern 1012 within the boundary of cell instance 410.

In FIG. 10A, metallization layout pattern 1022 extends along a second horizontal direction (e.g., the Y direction) and is outside the boundary of cell instance 410. In this example, a via pattern (not labeled) at Via2 layer (e.g., legend labeled as “Via2” in FIG. 10A) is outside the boundary of cell instance 410 and indicative of a via structure electrically connecting the conductive structures indicated by metallization layout patterns 1012 and 1022. In FIG. 10A, metallization layout pattern 1032 extends along the first horizontal direction (e.g., the X direction) and is outside the boundary of cell instance 410. In this example, a via pattern (not labeled) at Via3 layer (e.g., legend labeled as “Via3” in FIG. 10A) is outside the boundary of cell instance 410 and indicative of a via structure electrically connecting the conductive structures indicated by metallization layout patterns 1022 and 1032. Also, metallization layout pattern 1042 extends along the second horizontal direction (e.g., the Y direction) and is outside the boundary of cell instance 410. In this example, a via pattern (not labeled) at Via4 layer (e.g., legend labeled as “Via4” in FIG. 10A) is outside the boundary of cell instance 410 and indicative of a via structure electrically connecting the conductive structures indicated by metallization layout patterns 1032 and 1042.

In addition, two EM-violating metallization segments 1052 and 1054 are identified based on EM violation information. In this example, EM-violating metallization segment 1052 corresponds to a portion of metallization layout pattern 1012, and EM-violating metallization segment 1054 corresponds to an entirety of metallization layout pattern 1042. In FIG. 10A, EM-violating metallization segment 1052 is within a proximity window 1060 of cell instance 410, and EM-violating metallization segment 1054 is outside proximity window 1060 of cell instance 410. In some embodiments, proximity window 1060 is defined in a manner based on the example in FIG. 6.

FIG. 10B is a plan view 1000B including cell instance 410 with modified metallization segments to address the EM issue caused by EM-violating metallization segments 1052 and 1054, in accordance with some embodiments. Components and legends in FIG. 10B that are the same or similar to those in FIG. 10A are given the same reference numbers or reference labels, and the description thereof is thus simplified or omitted.

In this example, based on EM-violating metallization segment 1052 and in view of the examples in FIGS. 5 and 6, an added metallization segment 1014 is created, where added metallization segment 1014 and EM-violating metallization segment 1052 are in parallel along the X direction and aligned along the Y direction. Moreover, because the EM-violating metallization segment 1052 is within the proximity window 1060 of cell instance 410, added metallization segment 1014 and EM-violating metallization segment 1052 are marked as a set of must-join pins. Moreover, in view of the creation of added metallization segment 1014, metallization layout pattern 1022 is adjusted and/or extended to become metallization layout pattern 1022′ that is configured to accommodate formation of electrical connection by via structures at Via2 layer between the conductive structures indicated by metallization layout pattern 1022′ and metallization segment 1054.

In this example, based on EM-violating metallization segment 1054 and in view of the examples in FIGS. 5 and 6, an added metallization segment 1044 is created, where added metallization segment 1044 and EM-violating metallization segment 1054 are in parallel along the Y direction and aligned along the X direction. Moreover, because the EM-violating metallization segment 1054 is outside the proximity window 1060 of cell instance 410, added metallization segment 1044 and EM-violating metallization segment 1054 are not marked as a set of must-join pins. Moreover, in view of the creation of added metallization segment 1044, metallization layout pattern 1032 is adjusted and/or extended to become metallization layout pattern 1032′ that is configured to accommodate formation of electrical connection by via structures at Via3 layer between the conductive structures indicated by metallization layout pattern 1032′ and metallization segment 1044.

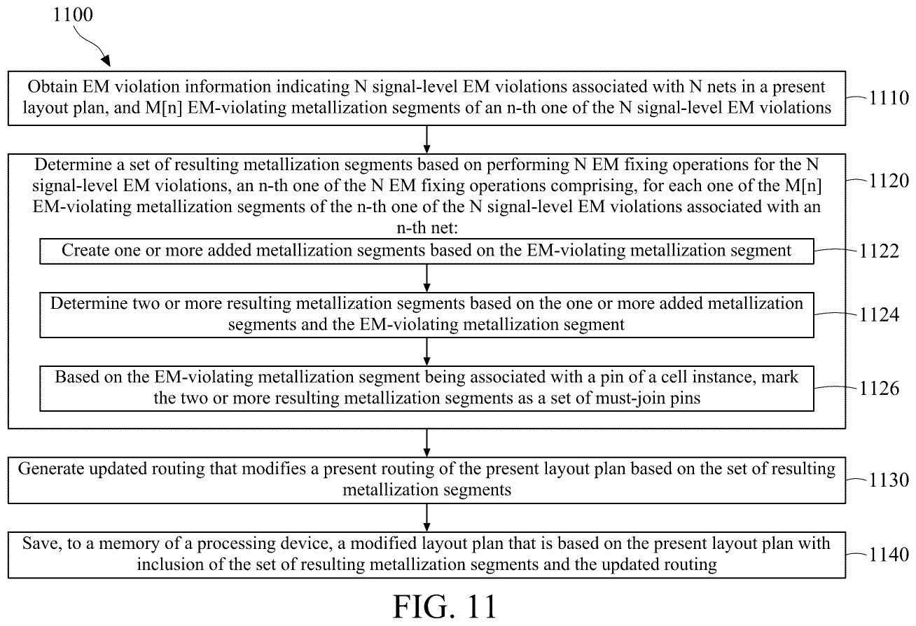

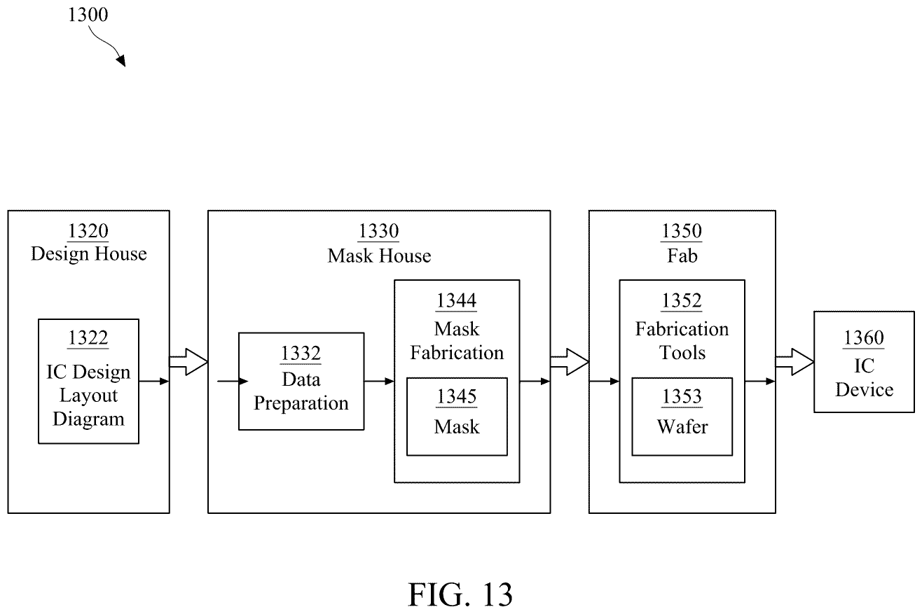

FIG. 11 is a flowchart of a method 1100 of generating a modified layout plan for a semiconductor device, in accordance with some embodiments. In some embodiments, method 1100 is based on signal EM fixing process 380 in FIG. 3B or signal EM fixing process 500 in FIG. 5, in view of the examples in FIGS. 4A-4D and 6-10B. In some embodiments, method 1100 is performed in conjunction with an IC manufacturing system as discussed with respect to the IC manufacturing system 1300 in FIG. 13. In some embodiments, method 1100 is performed based on an EDA system as discussed with respect to the EDA system in FIG. 12. Method 1100 includes blocks 1110-1140.

At block 1110, EM violation information is obtained. The EM violation information indicates N signal-level EM violations associated with N nets in a present layout plan, and M[n] EM-violating metallization segments of an n-th one of the N signal-level EM violations (e.g., stage 510 in FIG. 5). In some embodiments, N is a positive integer, n is a positive integer ranging from 1 to N, and M[n] is a positive integer. In some embodiments, the EM violation information indicates a first portion of a metallization layout pattern as an EM-violating metallization segment and a second portion of the metallization layout pattern as EM-compliant.

At block 1120, a set of resulting metallization segments is determined based on performing N EM fixing operations for the N signal-level EM violations. In one or more non-limiting examples, an n-th one of the N EM fixing operations includes, for each one of the M[n] EM-violating metallization segments of the n-th one of the N signal-level EM violations associated with an n-th net, actions as described in blocks 1122-1126 (e.g., stages 515-545 in FIG. 5).

At block 1122, one or more added metallization segments are created based on the EM-violating metallization segment, the one or more added metallization segments and the EM-violating metallization segment corresponding to a same metallization layer of the semiconductor device (e.g., stage 535 in FIG. 5).

At block 1124, two or more resulting metallization segments are determined based on the one or more added metallization segments and the EM-violating metallization segment (e.g., stage 535 in FIG. 5).

At block 1126, based on the EM-violating metallization segment being associated with a pin of a cell instance in the present layout plan and within a proximity window of the cell instance, the two or more resulting metallization segments are marked as a set of must-join pins (e.g., stage 535 in FIG. 5).

In some embodiments, for at least one of the N EM fixing operations, based on an EM-violating metallization segment of a signal-level EM violation being associated with a pin of a cell instance in the present layout plan and corresponding to a highest metallization layer of the signal-level EM violation, and based on the corresponding two or more resulting metallization segments being marked as a set of must-join pins, the corresponding two or more resulting metallization segments are assigned as a top pin of the cell instance in the modified layout plan (e.g., stage 550 in FIG. 5).

In some embodiments, the determining the set of resulting metallization segments further includes, for each one of the M[n] EM-violating metallization segments of the n-th one of the N signal-level EM violations associated with the n-th net, determining whether the present layout plan has qualifying routing resources for accommodating the one or more added metallization segments adjacent to the corresponding EM-violating metallization segment, in parallel with the corresponding EM-violating metallization segment along a first horizontal direction, and aligned with the corresponding EM-violating metallization segment along a second horizontal direction. in some embodiments, based on the present layout plan being determined as having the qualifying routing resources, method 1100 includes creating the one or more added metallization segments that are adjacent to the corresponding EM-violating metallization segment, in parallel with the corresponding EM-violating metallization segment along a first horizontal direction, and aligned with the corresponding EM-violating metallization segment along a second horizontal direction, the two or more resulting metallization segments including the one or more added metallization segments and the corresponding EM-violating metallization segment (e.g., the examples in FIGS. 7A-7D).

In some embodiments, based on the present layout plan being determined as not having the qualifying routing resources, method 1100 further includes generating a shifted EM-violating metallization segment based on shifting the corresponding EM-violating metallization segment to a connection window, and creating the one or more added metallization segments that are adjacent to the shifted EM-violating metallization segment, in parallel with the shifted EM-violating metallization segment along the first horizontal direction, and aligned with the shifted EM-violating metallization segment along the second horizontal direction, the two or more resulting metallization segments including the one or more added metallization segments and the shifted EM-violating metallization segment (e.g., the examples in FIGS. 9A-9D).

In some embodiments, method 1100 further includes, for one of the M[n] EM-violating metallization segments of the n-th one of the N signal-level EM violations associated with the n-th net, based on the shifted EM-violating metallization segment being generated, shifting one or more upper metallization layout patterns associated with the n-th net at one or more upper metallization layers to the connection window.

In some embodiments, the set of resulting metallization segments is determined based on a proximity window of a cell instance (e.g., the examples in FIG. 6). In some embodiments, the proximity window is determinable based on a first predetermined distance along a cell height direction to a boundary of the cell instance, a second predetermined distance along a cell width direction to the boundary of the cell instance, a set of coordinates based on a user input, a set of routing rules, an associated metallization layer, or a combination thereof.

At block 1130, an updated routing that modifies a present routing of the present layout plan is generated based on the set of resulting metallization segments (e.g., stage 560 in FIG. 5). In some embodiments, the updated routing is generated based on an ECO process.

At block 1140, a modified layout plan is saved to a memory of a processing device. In some embodiments, the modified layout plan is based on the present layout plan with inclusion of the set of resulting metallization segments and the updated routing.

In some embodiments, method 1100 further includes obtaining, as the present layout plan, a first layout plan that corresponds to a result of a clock tree synthesis process prior to a routing process. In some embodiments, method 1100 further includes obtaining, as the present layout plan, a second layout plan that corresponds to a result of the routing process.

FIG. 12 is a block diagram of an electronic design automation (EDA) system 1200 in accordance with some embodiments. In some embodiments, EDA system 1200 includes an automatic placement and routing (APR) system. Methods described herein in accordance with one or more embodiments are implementable, for example, using EDA system 1200, in accordance with some embodiments.

In some embodiments, EDA system 1200 is a general-purpose computing device including a hardware processor 1202 and a computer-readable storage medium 1204. Storage medium 1204, amongst other things, is encoded with, i.e., stores, computer program code 1206, i.e., a set of executable instructions. Execution of instructions 1206 by hardware processor 1202 represents (at least in part) an EDA tool which implements a portion or all of the methods described herein in accordance with one or more embodiments (hereinafter, the noted processes and/or methods).

Processor 1202 is electrically coupled to computer-readable storage medium 1204 via a bus 1208. Processor 1202 is also electrically coupled to an I/O interface 1210 by bus 1208. A network interface 1212 is also electrically connected to processor 1202 via bus 1208. Network interface 1212 is connected to a network 1214, so that processor 1202 and computer-readable storage medium 1204 are capable of connecting to external elements via network 1214. Processor 1202 is configured to execute computer program code 1206 encoded in computer-readable storage medium 1204 in order to cause system 1200 to be usable for performing a portion or all of the noted processes and/or methods. In one or more embodiments, processor 1202 is a CPU, a multi-processor, a distributed processing system, an application specific integrated circuit (ASIC), and/or a suitable processing unit.

In one or more embodiments, computer-readable storage medium 1204 is a non-transitory computer-readable storage medium including an electronic, magnetic, optical, electromagnetic, infrared, and/or a semiconductor system (or apparatus or device). For example, computer-readable storage medium 1204 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 1204 includes a compact disk-read only memory (CD-ROM), a compact disk-read/write (CD-R/W), and/or a digital video disc (DVD).

In one or more embodiments, storage medium 1204 stores computer program code 1206 configured to cause system 1200 (where such execution represents (at least in part) the EDA tool) to be usable for performing a portion or all of the noted processes and/or methods. In one or more embodiments, storage medium 1204 also stores information which facilitates performing a portion or all of the noted processes and/or methods. In one or more embodiments, storage medium 1204 stores a cell library 1207 of standard cells including such standard cells as disclosed herein. In one or more embodiments, storage medium 1204 stores one or more layout plans 1209 corresponding to one or more layout plans disclosed herein.

EDA system 1200 includes I/O interface 1210. I/O interface 1210 is coupled to external circuitry. In one or more embodiments, I/O interface 1210 includes a keyboard, keypad, mouse, trackball, trackpad, touchscreen, and/or cursor direction keys for communicating information and commands to processor 1202.

EDA system 1200 also includes network interface 1212 coupled to processor 1202. Network interface 1212 allows system 1200 to communicate with network 1214, to which one or more other computer systems are connected. Network interface 1212 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 1200.

System 1200 is configured to receive information through I/O interface 1210. The information received through I/O interface 1210 includes one or more of instructions, data, design rules, libraries of standard cells, and/or other parameters for processing by processor 1202. The information is transferred to processor 1202 via bus 1208. EDA system 1200 is configured to receive information related to a UI through I/O interface 1210. The information is stored in computer-readable medium 1204 as user interface (UI) 1242.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 1200. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 13 is a block diagram of an IC manufacturing system 1300, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 1300.

In FIG. 13, IC manufacturing system 1300 includes entities, such as a design house 1320, a mask house 1330, and an IC manufacturer/fabricator (fab) 1350, that interact with one another in the design, development, and manufacturing cycles and/or services related to manufacturing an IC device 1360. The entities in system 1300 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1320, mask house 1330, and IC fab 1350 is owned by a single larger company. In some embodiments, two or more of design house 1320, mask house 1330, and IC fab 1350 coexist in a common facility and use common resources.

Design house (or design team) 1320 generates an IC design layout diagram 1322 (e.g., a layout plan). IC design layout diagram 1322 includes various geometrical patterns designed for an IC device 1360. The geometrical patterns correspond to patterns of metal, oxide, or semiconductor layers that make up the various components of IC device 1360 to be fabricated. The various layers combine to form various IC features. For example, a portion of IC design layout diagram 1322 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1320 implements a proper design procedure to form IC design layout diagram 1322. The design procedure includes one or more of logic design, physical design or place and route. IC design layout diagram 1322 is presented in one or more data files having information of the geometrical patterns. For example, IC design layout diagram 1322 can be expressed in a GDSII file format or DFII file format.

Mask house 1330 includes data preparation 1332 and mask fabrication 1344. Mask house 1330 uses IC design layout diagram 1322 to manufacture one or more masks 1345 to be used for fabricating the various layers of IC device 1360 according to IC design layout diagram 1322. Mask house 1330 performs mask data preparation 1332, where IC design layout diagram 1322 is translated into a representative data file (RDF). Mask data preparation 1332 provides the RDF to mask fabrication 1344. Mask fabrication 1344 includes a mask writer. A mask writer converts the RDF to an image on a substrate, such as a mask (reticle) 1345 or a semiconductor wafer 1353. The design layout diagram 1322 is manipulated by mask data preparation 1332 to comply with particular characteristics of the mask writer and/or requirements of IC fab 1350. In FIG. 13, mask data preparation 1332 and mask fabrication 1344 are illustrated as separate elements. In some embodiments, mask data preparation 1332 and mask fabrication 1344 can be collectively referred to as mask data preparation.

In some embodiments, mask data preparation 1332 includes optical proximity correction (OPC) which uses lithography enhancement techniques to compensate for image errors, such as those that can arise from diffraction, interference, other process effects and the like. OPC adjusts IC design layout diagram 1322. In some embodiments, mask data preparation 1332 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1332 includes a mask rule checker (MRC) that checks the IC design layout diagram 1322 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1322 to compensate for photolithographic implementation effects during mask fabrication 1344, which may undo part of the modifications performed by OPC in order to meet mask creation rules.

In some embodiments, mask data preparation 1332 includes lithography process checking (LPC) that simulates processing that will be implemented by IC fab 1350 to fabricate IC device 1360. LPC simulates this processing based on IC design layout diagram 1322 to create a simulated manufactured device, such as IC device 1360. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (DOF), mask error enhancement factor (MEEF), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1322.

It should be understood that the above description of mask data preparation 1332 has been simplified for the purposes of clarity. In some embodiments, data preparation 1332 includes additional features such as a logic operation (LOP) to modify the IC design layout diagram 1322 according to manufacturing rules. Additionally, the processes applied to IC design layout diagram 1322 during data preparation 1332 may be executed in a variety of different orders.

After mask data preparation 1332 and during mask fabrication 1344, a mask 1345 or a group of masks 1345 are fabricated based on the modified IC design layout diagram 1322. In some embodiments, mask fabrication 1344 includes performing one or more lithographic exposures based on IC design layout diagram 1322. In some embodiments, an electron-beam (e-beam) or a mechanism of multiple e-beams is used to form a pattern on a mask (photomask or reticle) 1345 based on the modified IC design layout diagram 1322. Mask 1345 can be formed in various technologies. In some embodiments, mask 1345 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1345 includes a transparent substrate (e.g., fused quartz) and an opaque material (e.g., chromium) coated in the opaque regions of the binary mask. In another example, mask 1345 is formed using a phase shift technology. In a phase shift mask (PSM) version of mask 1345, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1344 is used in a variety of processes. For example, such a mask(s) is used in an ion implantation process to form various doped regions in semiconductor wafer 1353, in an etching process to form various etching regions in semiconductor wafer 1353, and/or in other suitable processes.

IC fab 1350 is an IC fabrication business that includes one or more manufacturing facilities for the fabrication of a variety of different IC products. In some embodiments, IC fab 1350 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1350 includes fabrication tools 1352 configured to execute various manufacturing operations on semiconductor wafer 1353 such that IC device 1360 is fabricated in accordance with the mask(s), e.g., mask 1345. In various embodiments, fabrication tools 1352 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1350 uses mask(s) 1345 fabricated by mask house 1330 to fabricate IC device 1360. Thus, IC fab 1350 at least indirectly uses IC design layout diagram 1322 to fabricate IC device 1360. In some embodiments, semiconductor wafer 1353 is fabricated by IC fab 1350 using mask(s) 1345 to form IC device 1360. In some embodiments, the IC fabrication includes performing one or more lithographic exposures based at least indirectly on IC design layout diagram 1322. Semiconductor wafer 1353 includes a silicon substrate or other proper substrate having material layers formed thereon. Semiconductor wafer 1353 further includes one or more of various doped regions, dielectric features, multilevel interconnects, and the like (formed at subsequent manufacturing steps).

In some aspects, a method of generating a modified layout plan for a semiconductor device includes obtaining electromigration (EM) violation information indicating N signal-level EM violations associated with N nets in a present layout plan, and M[n] EM-violating metallization segments of an n-th one of the N signal-level EM violations, N being a positive integer, n being a positive integer ranging from 1 to N, and M[n] being a positive integer, and determining a set of resulting metallization segments based on performing N EM fixing operations for the N signal-level EM violations. An n-th one of the N EM fixing operations includes, for each one of the M[n] EM-violating metallization segments of the n-th one of the N signal-level EM violations associated with an n-th net, creating one or more added metallization segments based on the EM-violating metallization segment, the one or more added metallization segments and the EM-violating metallization segment corresponding to a same metallization layer of the semiconductor device, determining two or more resulting metallization segments based on the one or more added metallization segments and the EM-violating metallization segment, and based on the EM-violating metallization segment being associated with a pin of a cell instance in the present layout plan and within a proximity window of the cell instance, marking the two or more resulting metallization segments as a set of must-join pins. The method further includes generating an updated routing that modifies a present routing of the present layout plan based on the set of resulting metallization segments, saving, to a memory of a processing device, a modified layout plan that is based on the present layout plan with inclusion of the set of resulting metallization segments and the updated routing.

In some aspects, a processing device for generating a modified layout plan for a semiconductor device includes a memory and processing circuitry coupled to the memory. The processing circuitry is configured to obtain electromigration (EM) violation information indicating N signal-level EM violations associated with N nets in a present layout plan, and M[n] EM-violating metallization segments of an n-th one of the N signal-level EM violations, N being a positive integer, n being a positive integer ranging from 1 to N, and M[n] being a positive integer, and determine a set of resulting metallization segments based on performing N EM fixing operations for the N signal-level EM violations. The processing circuitry configured to perform an n-th one of the N EM fixing operations is further configured to, for each one of the M[n] EM-violating metallization segments of the n-th one of the N signal-level EM violation associated with an n-th net, create one or more added metallization segments based on the EM-violating metallization segment, the one or more added metallization segments and the EM-violating metallization segment corresponding to a same metallization layer of the semiconductor device, determine two or more resulting metallization segments based on the one or more added metallization segments and the EM-violating metallization segment, and based on the EM-violating metallization segment being associated with a pin of a cell instance in the present layout plan and within a proximity window of the cell instance, mark the two or more resulting metallization segments as a set of must-join pins. The processing circuitry is further configured to generate an updated routing that modifies a present routing of the present layout plan based on the set of resulting metallization segments, and save, to the memory, a modified layout plan that is based on the present layout plan with inclusion of the set of resulting metallization segments and the updated routing.

In some aspects, a non-transitory computer-readable medium that stores instructions which, when executed by processing circuitry of a processing device, cause the processing device to obtain electromigration (EM) violation information indicating N signal-level EM violations associated with N nets in a present layout plan for a semiconductor device, and M[n] EM-violating metallization segments of an n-th one of the N signal-level EM violations, N being a positive integer, n being a positive integer ranging from 1 to N, and M[n] being a positive integer, and determine a set of resulting metallization segments based on performing N EM fixing operations for the N signal-level EM violations. The instructions causing the processing device to perform an n-th one of the N EM fixing operations include instructions that cause the processing device to, for each one of the M[n] EM-violating metallization segments of the n-th one of the N signal-level EM violation associated with an n-th net, create one or more added metallization segments based on the EM-violating metallization segment, the one or more added metallization segments and the EM-violating metallization segment corresponding to a same metallization layer of the semiconductor device, determine two or more resulting metallization segments based on the one or more added metallization segments and the EM-violating metallization segment, and based on the EM-violating metallization segment being associated with a pin of a cell instance in the present layout plan and within a proximity window of the cell instance, mark the two or more resulting metallization segments as a set of must-join pins.

The instructions further cause the processing device to generate updated routing that modifies a present routing of the present layout plan based on the set of resulting metallization segments, and save, to a memory of the processing device, a modified layout plan for the semiconductor device, the modified layout plan being based on the present layout plan with inclusion of the set of resulting metallization segments and the updated routing.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

1. A method of generating a modified layout plan for a semiconductor device, the method comprising:
obtaining electromigration (EM) violation information indicating N signal-level EM violations associated with N nets in a present layout plan, and M[n] EM-violating metallization segments of an n-th one of the N signal-level EM violations, N being a positive integer, n being a positive integer ranging from 1 to N, and M[n] being a positive integer;
determining a set of resulting metallization segments based on performing N EM fixing operations for the N signal-level EM violations, an n-th one of the N EM fixing operations comprising, for each one of the M[n] EM-violating metallization segments of the n-th one of the N signal-level EM violations associated with an n-th net:
creating one or more added metallization segments based on the EM-violating metallization segment, the one or more added metallization segments and the EM-violating metallization segment corresponding to a same metallization layer of the semiconductor device;
determining two or more resulting metallization segments based on the one or more added metallization segments and the EM-violating metallization segment; and
based on the EM-violating metallization segment being associated with a pin of a cell instance in the present layout plan and within a proximity window of the cell instance, marking the two or more resulting metallization segments as a set of must-join pins;
generating an updated routing that modifies a present routing of the present layout plan based on the set of resulting metallization segments; and
saving, to a memory of a processing device, a modified layout plan that is based on the present layout plan with inclusion of the set of resulting metallization segments and the updated routing.

2. The method of claim 1, wherein one of the N EM fixing operations further comprises:
based on an EM-violating metallization segment of a signal-level EM violation being associated with a pin of a cell instance in the present layout plan and corresponding to a highest metallization layer of the signal-level EM violation, and based on the corresponding two or more resulting metallization segments being marked as a set of must-join pins, assigning the corresponding two or more resulting metallization segments as a top pin of the cell instance in the modified layout plan.

3. The method of claim 1, further comprising:
obtaining, as the present layout plan, a first layout plan that corresponds to a result of a clock tree synthesis process prior to a routing process, or
obtaining, as the present layout plan, a second layout plan that corresponds to a result of the routing process.

4. The method of claim 1, wherein
the generating the updated routing is performed based on an engineering change order (ECO) process.

5. The method of claim 1, wherein the determining the set of resulting metallization segments further comprises, for each one of the M[n] EM-violating metallization segments of the n-th one of the N signal-level EM violations associated with the n-th net:
determining whether the present layout plan has qualifying routing resources for accommodating the one or more added metallization segments adjacent to the corresponding EM-violating metallization segment, in parallel with the corresponding EM-violating metallization segment along a first horizontal direction, and aligned with the corresponding EM-violating metallization segment along a second horizontal direction;
based on the present layout plan being determined as having the qualifying routing resources,
creating the one or more added metallization segments that are adjacent to the corresponding EM-violating metallization segment, in parallel with the corresponding EM-violating metallization segment along the first horizontal direction, and aligned with the corresponding EM-violating metallization segment along the second horizontal direction, the two or more resulting metallization segments including the one or more added metallization segments and the corresponding EM-violating metallization segment;
based on the present layout plan being determined as not having the qualifying routing resources,
generating a shifted EM-violating metallization segment based on shifting the corresponding EM-violating metallization segment to a connection window, and
creating the one or more added metallization segments that are adjacent to the shifted EM-violating metallization segment, in parallel with the shifted EM-violating metallization segment along the first horizontal direction, and aligned with the shifted EM-violating metallization segment along the second horizontal direction, the two or more resulting metallization segments including the one or more added metallization segments and the shifted EM-violating metallization segment.

6. The method of claim 5, further comprising:
for one of the M[n] EM-violating metallization segments of the n-th one of the N signal-level EM violations associated with the n-th net, based on the shifted EM-violating metallization segment being generated, shifting one or more upper metallization layout patterns associated with the n-th net at one or more upper metallization layers to the connection window.

7. The method of claim 1, wherein
the EM violation information indicates a first portion of a metallization layout pattern as an EM-violating metallization segment and a second portion of the metallization layout pattern as EM-compliant.

8. The method of claim 1, wherein the determining the set of resulting metallization segments is based on the proximity window of the cell instance, the proximity window being determinable based on:
a first predetermined distance along a cell height direction to a boundary of the cell instance,
a second predetermined distance along a cell width direction to the boundary of the cell instance,
a set of coordinates based on a user input,
a set of routing rules,
an associated metallization layer, or
a combination thereof.

9. A processing device for generating a modified layout plan for a semiconductor device, comprising:
a memory; and
processing circuitry coupled to the memory and configured to:
obtain electromigration (EM) violation information indicating N signal-level EM violations associated with N nets in a present layout plan, and M[n] EM-violating metallization segments of an n-th one of the N signal-level EM violations, N being a positive integer, n being a positive integer ranging from 1 to N, and M[n] being a positive integer;
determine a set of resulting metallization segments based on performing N EM fixing operations for the N signal-level EM violations, the processing circuitry configured to perform an n-th one of the N EM fixing operations further configured to, for each one of the M[n] EM-violating metallization segments of the n-th one of the N signal-level EM violation associated with an n-th net:
create one or more added metallization segments based on the EM-violating metallization segment, the one or more added metallization segments and the EM-violating metallization segment corresponding to a same metallization layer of the semiconductor device;
determine two or more resulting metallization segments based on the one or more added metallization segments and the EM-violating metallization segment; and
based on the EM-violating metallization segment being associated with a pin of a cell instance in the present layout plan and within a proximity window of the cell instance, mark the two or more resulting metallization segments as a set of must-join pins;
generate an updated routing that modifies a present routing of the present layout plan based on the set of resulting metallization segments; and
save, to the memory, a modified layout plan that is based on the present layout plan with inclusion of the set of resulting metallization segments and the updated routing.

10. The processing device of claim 9, wherein the processing circuitry configured to perform one of the N EM fixing operations is further configured to:
based on an EM-violating metallization segment of a signal-level EM violation being associated with a pin of a cell instance in the present layout plan and corresponding to a highest metallization layer of the signal-level EM violation, and based on the corresponding two or more resulting metallization segments being marked as a set of must-join pins, assign the corresponding two or more resulting metallization segments as a top pin of the cell instance in the modified layout plan.

11. The processing device of claim 9, wherein the processing circuitry is further configured to:
obtain, as the present layout plan, a first layout plan that corresponds to a result of a clock tree synthesis process prior to a routing process, or
obtain, as the present layout plan, a second layout plan that corresponds to a result of the routing process.

12. The processing device of claim 9, wherein the processing circuitry configured to determine the set of resulting metallization segments is further configured to, for each one of the M[n] EM-violating metallization segments of the n-th one of the N signal-level EM violations associated with the n-th net:
determine whether the present layout plan has qualifying routing resources for accommodating the one or more added metallization segments adjacent to the corresponding EM-violating metallization segment, in parallel with the corresponding EM-violating metallization segment along a first horizontal direction, and aligned with the corresponding EM-violating metallization segment along a second horizontal direction;
based on the present layout plan being determined as having the qualifying routing resources,
create the one or more added metallization segments that are adjacent to the corresponding EM-violating metallization segment, in parallel with the corresponding EM-violating metallization segment along [[a]]the first horizontal direction, and aligned with the corresponding EM-violating metallization segment along [[a]]the second horizontal direction, the two or more resulting metallization segments including the one or more added metallization segments and the corresponding EM-violating metallization segment;
based on the present layout plan being determined as not having the qualifying routing resources,
generate a shifted EM-violating metallization segment based on shifting the corresponding EM-violating metallization segment to a connection window, and
create the one or more added metallization segments that are adjacent to the shifted EM-violating metallization segment, in parallel with the shifted EM-violating metallization segment along the first horizontal direction, and aligned with the shifted EM-violating metallization segment along the second horizontal direction, the two or more resulting metallization segments including the one or more added metallization segments and the shifted EM-violating metallization segment.

13. The processing device of claim 12, wherein the processing circuitry is further configured to:
for one of the M[n] EM-violating metallization segments of the n-th one of the N signal-level EM violations associated with the n-th net, based on the shifted EM-violating metallization segment being generated, shift one or more upper metallization layout patterns associated with the n-th net at one or more upper metallization layers to the connection window.

14. The processing device of claim 9, wherein
the EM violation information indicates a first portion of a metallization layout pattern as an EM-violating metallization segment and a second portion of the metallization layout pattern as EM-compliant.

15. The processing device of claim 9, wherein the processing circuitry is configured to determine the set of resulting metallization segments based on the proximity window of the cell instance, the proximity window being determinable based on:
a first predetermined distance along a cell height direction to a boundary of the cell instance,
a second predetermined distance along a cell width direction to the boundary of the cell instance,
a set of coordinates based on a user input,
a set of routing rules,
an associated metallization layer, or
a combination thereof.

16. A non-transitory computer-readable medium that stores instructions which, when executed by processing circuitry of a processing device, cause the processing device to:
obtain electromigration (EM) violation information indicating N signal-level EM violations associated with N nets in a present layout plan for a semiconductor device, and M[n] EM-violating metallization segments of an n-th one of the N signal-level EM violations, N being a positive integer, n being a positive integer ranging from 1 to N, and M[n] being a positive integer;
determine a set of resulting metallization segments based on performing N EM fixing operations for the N signal-level EM violations, the instructions causing the processing device to perform an n-th one of the N EM fixing operations including instructions that cause the processing device to, for each one of the M[n] EM-violating metallization segments of the n-th one of the N signal-level EM violation associated with an n-th net:
create one or more added metallization segments based on the EM-violating metallization segment, the one or more added metallization segments and the EM-violating metallization segment corresponding to a same metallization layer of the semiconductor device;
determine two or more resulting metallization segments based on the one or more added metallization segments and the EM-violating metallization segment; and
based on the EM-violating metallization segment being associated with a pin of a cell instance in the present layout plan and within a proximity window of the cell instance, mark the two or more resulting metallization segments as a set of must-join pins;
generate an updated routing that modifies a present routing of the present layout plan based on the set of resulting metallization segments; and
save, to a memory of the processing device, a modified layout plan for the semiconductor device, the modified layout plan being based on the present layout plan with inclusion of the set of resulting metallization segments and the updated routing.

17. The non-transitory computer-readable medium of claim 16, wherein the instructions causing the processing device to perform one of the N EM fixing operations includes instructions that cause the processing device to:
based on an EM-violating metallization segment of a signal-level EM violation being associated with a pin of a cell instance in the present layout plan and corresponding to a highest metallization layer of the signal-level EM violation, and based on the corresponding two or more resulting metallization segments being marked as a set of must-join pins, assign the corresponding two or more resulting metallization segments as a top pin of the cell instance in the modified layout plan.

18. The non-transitory computer-readable medium of claim 16, wherein the instructions further cause the processing device to:
obtain, as the present layout plan, a first layout plan that corresponds to a result of a clock tree synthesis process prior to a routing process, or
obtain, as the present layout plan, a second layout plan that corresponds to a result of the routing process.

19. The non-transitory computer-readable medium of claim 16, wherein the instructions causing the processing device to determine the set of resulting metallization segments include instructions causing the processing device to, for each one of the M[n] EM-violating metallization segments of the n-th one of the N signal-level EM violations associated with the n-th net:
determine whether the present layout plan has qualifying routing resources for accommodating the one or more added metallization segments adjacent to the corresponding EM-violating metallization segment, in parallel with the corresponding EM-violating metallization segment along a first horizontal direction, and aligned with the corresponding EM-violating metallization segment along a second horizontal direction;
based on the present layout plan being determined as having the qualifying routing resources,
create the one or more added metallization segments that are adjacent to the corresponding EM-violating metallization segment, in parallel with the corresponding EM-violating metallization segment along the first horizontal direction, and aligned with the corresponding EM-violating metallization segment along the second horizontal direction, the two or more resulting metallization segments including the one or more added metallization segments and the corresponding EM-violating metallization segment;
based on the present layout plan being determined as not having the qualifying routing resources,
generate a shifted EM-violating metallization segment based on shifting the corresponding EM-violating metallization segment to a connection window, and
create the one or more added metallization segments that are adjacent to the shifted EM-violating metallization segment, in parallel with the shifted EM-violating metallization segment along the first horizontal direction, and aligned with the shifted EM-violating metallization segment along the second horizontal direction, the two or more resulting metallization segments including the one or more added metallization segments and the shifted EM-violating metallization segment.

20. The non-transitory computer-readable medium of claim 16, wherein the instructions cause the processing device to generate the set of resulting metallization segments based on the proximity window of the cell instance, the proximity window being determinable based on:
a first predetermined distance along a cell height direction to a boundary of the cell instance,
a second predetermined distance along a cell width direction to the boundary of the cell instance,
a set of coordinates based on a user input,
a set of routing rules,
an associated metallization layer, or
a combination thereof.
